(19) United States
(12) Patent Application Publication
(10) Pub. No.: US 2026/0197539 A1
(43) Pub. Date: Jul. 9, 2026

(54) SNAPSHOT MULTISPECTRAL IMAGING USING A DIFFRACTIVE OPTICAL NETWORK

(71) Applicant: THE REGENTS OF THE UNIVERSITY OF CALIFORNIA, Oakland, CA (US)

(72) Inventors: Aydogan Ozcan, Los Angeles, CA (US); Deniz Mengu, Los Angeles, CA (US)

(73) Assignee: THE REGENTS OF THE UNIVERSITY OF CALIFORNIA, Oakland, CA (US)

(21) Appl. No.: 19/134,685

(22) PCT Filed: Nov. 10, 2023
(86) PCT No.: PCT/US2023/079436

§ 371 Date: May 30, 2025

Related U.S. Application Data
(60) Provisional application No. 63/386,766, filed on Dec. 9, 2022.

(51) Int. Cl. H04N 23/12; G02B 27/42; H04N 23/56; H04N 23/84

(52) U.S. Cl. CPC H04N 23/12; G02B 27/4205; G02B 27/4294; H04N 23/56; H04N 23/843

(57) ABSTRACT

A diffractive optical network-based multispectral imaging system is trained using deep learning to create a virtual spectral filter array at the output image field-of-view. The diffractive multispectral imager performs spatially-coherent imaging over a large spectrum, and at the same time, routes a pre-determined set of spectral channels onto an array of pixels at the output plane, converting a monochrome focal plane array or image sensor into a multispectral imaging device without any spectral filters or image recovery algorithms. Furthermore, the spectral responsivity of this diffractive multispectral imager is not sensitive to input polarization states. Due to its compact form factor and computation-free, power-efficient and polarization-insensitive forward operation, the diffractive multispectral imager can be transformative for various imaging and sensing applications and be used at different parts of the electromagnetic spectrum where high-density and wide-area multispectral pixel arrays are not widely available.

### RELATED APPLICATION

This application claims priority to U.S. Provisional Patent Application No. 63/386,766 filed on Dec. 9, 2022, which is hereby incorporated by reference. Priority is claimed pursuant to 35 U.S.C. § 119 and any other applicable statute.

### STATEMENT REGARDING FEDERALLY SPONSORED RESEARCH AND DEVELOPMENT

This invention was made with government support under DE-SC0023088 awarded by the Department of Energy. The government has certain rights in the invention.

### TECHNICAL FIELD

The technical field generally relates to optical-based deep learning physical architectures or platforms that can perform imaging operations. In particular, the technical field relates to optical-based architectures and platforms that perform snapshot multispectral imaging. The system uses passive spatially-structured diffractive surfaces that capture multispectral images at one or more wavelengths or spectral bands.

### BACKGROUND

Multispectral imaging has been an instrumental tool for major advances in various fields, including environmental monitoring, astronomy, agricultural sciences, biological imaging, medical diagnostics, and food quality control among many others. One of the simplest ways to achieve multispectral imaging is to sacrifice the image acquisition time in favor of the spectral information by capturing multiple shots of a scene while changing the spectral filter in front of a monochrome camera. Another traditional form of multispectral imaging relies on push-broom scanning of a one-dimensional detector array across the field-of-view (FOV). While these multispectral imaging techniques provide sufficient spectral and spatial resolution, they suffer from relatively long data acquisition times, hindering their use in real-time imaging applications. An alternative solution that allows simultaneous collection of the spatial and spectral information is to split the optical waves emanating from the input FOV onto different optical paths each containing a different spectral filter, followed by a 2D monochrome image sensor array. However, this approach often leads to more complex and bulky optical systems since it requires the use of multiple focal-plane arrays, one for each band, along with other optical components.

Modern-day snapshot spectral imaging systems often use coded apertures in conjunction with computational image recovery algorithms to digitally mitigate these shortcomings of traditional multispectral imaging systems. One of the earliest forms of coded aperture snapshot spectral imaging used a binary spatial aperture function imaged onto a dispersive optical element through relay optics, encoding both the spatial and spectral features contained within the input FOV into an intensity pattern collected by a monochrome focal-plane array. Since this initial proof-of-concept demonstration, various improvements have been reported on coded aperture-based snapshot spectral imaging systems based on, e.g., the use of color-coded apertures, compressive sensing techniques and others. On the other hand, these systems still require the use of optical relay systems and dispersive optical elements such as prisms, and diffractive elements, resulting in bulky form factors. Furthermore, their frame rate is often limited by the computationally intense iterative recovery algorithms that are used to digitally retrieve the multispectral image cube from the raw data. Recent studies have also reported using diffractive lens designs, addressing the form factor limitations of multispectral imaging systems. These approaches provide restricted spatial and spectral encoding capabilities due to their limited degrees of freedom without coded apertures, causing relatively poor spectral resolution. Recent work also demonstrated the use of feedforward deep neural networks to achieve better image reconstruction quality, addressing some of the limitations imposed by the iterative reconstruction algorithms typically employed in multispectral imaging and sensing. On the other hand, deep learning-enabled computational multispectral imagers require access to powerful graphics processing units (GPUs) for rapid inference of each spectral image cube and rely on training data acquisition or a calibration process to characterize their point spread functions.

With the development of high-resolution image sensor-arrays, it has become more practical to compromise spatial resolution to collect richer spectral information. The most ubiquitous form of a relatively primitive spectral imaging device designed around this trade-off is a color camera based on the Bayer filters (R, G, B channels, representing the red, green and blue spectral bands, respectively). The traditional RGB color image sensor is based on a periodically repeating array of 2×2 pixels, with each subpixel containing an absorptive spectral filter (also known as the Bayer filters) that transmits the red, green, or blue wavelengths while partially blocking the others. Despite its frequent use in various imaging applications, there has been a tremendous effort to develop better alternatives to these absorptive filters that suffer from a relatively high-cross talk, low power efficiency, and poor color representation. Towards this end, numerous engineered optical material structures have been explored, including plasmonic antennas, dielectric metasurfaces and 3D porous materials. While the intrinsic losses associated with metallic nanostructures limit their optical efficiency, multispectral imager designs based on dielectric metasurfaces and 3D porous compound optical elements have been reported to achieve higher power efficiencies with lower color crosstalk. However, these structured material-based approaches, including various metamaterial designs, were all limited to four or fewer spectral channels, and did not demonstrate a large array of spectral filters for multispectral imaging. Independent from these spectral filtering techniques based on optimized meta-designs, increasing the number of unique spectral channels in conventional multispectral filters was also demonstrated, which, in general, poses various design and implementation challenges for scale-up.

### SUMMARY

In one embodiment, a snapshot multispectral imager is disclosed that is based on a diffractive optical network (also known as D²NN or diffractive deep neural network). The performance is demonstrated with four (4) (2×2), nine (9) (3×3) and sixteen (16) (4×4) unique spectral bands that are periodically repeating at the output image FOV to form a virtual multispectral filter array. This diffractive network-based multispectral imager is trained to project the spatial information of an object onto a grid of virtual pixels, with each one carrying the information of a pre-determined spectral band, performing snapshot multispectral imaging via engineered diffraction of light through passive transmissive layers that axially span ~72λₘ, where λₘ is the mean wavelength of the entire spectral band of interest. This unique multispectral imager design based on diffractive optical networks achieves two tasks simultaneously: (1) its acts as a broadband spatially-coherent relay optics achieving the optical imaging task between the input and the output FOVs over a wide spectral range; and (2) it spatially separates the input spectral channels into distinct pixels at the same output image plane, serving as a virtual spectral filter array that preserves the spatial information of the scene/object, instantaneously yielding an image cube without image reconstruction algorithms, except the standard demosaicing of the virtual filter array pixels. Stated differently, a diffractive optical network is demonstrated that virtually converts a monochrome focal plane array or an image sensor into a snapshot multispectral imaging device without the need for conventional spectral filters.

Different numerical diffractive network designs are disclosed that achieve multispectral coherent imaging with four (4), nine (9) and sixteen (16) unique spectral bands within the visible spectrum based on passive diffractive layers that are laterally engineered at a feature size of ~225 nm, spanning ~43 μm in the axial direction from the first layer to the last, forming a compact and scalable design. The numerical analyses on the spectral signal contrast provided by these diffractive multispectral imagers reveal that for a given array of virtual filter pixels (covering, e.g., four (4), nine (9) and sixteen (16) spectral bands), the mean optical power of each one of the targeted spectral bands is approximately an order of magnitude larger compared to the average optical power of the other wavelengths, which reduces crosstalk issues.

Furthermore, the success of the diffractive multispectral imager is demonstrated experimentally using a 3D-printed diffractive network operating at terahertz wavelengths. Targeting peak frequencies at 0.375, 0.400, 0.425 and 0.450 THz, the fabricated diffractive network with three (3) structured transmissive layers can successfully route each spectral component onto a corresponding array of virtual pixels at the output image plane, forming a multispectral coherent imager with four (4) spectral channels. Although the imager focused on spatially-coherent multispectral imaging, phase-only diffractive layers can also be optimized using deep learning to create spatially incoherent snapshot multispectral imagers, following the same design principles outlined here. With its compact form factor and snapshot operation without any image cube reconstruction algorithms, the presented diffractive multispectral imaging framework can be transformative in various imaging and sensing applications.

Since the presented diffractive multispectral imagers utilize isotropic dielectric materials, their virtual spectral filter arrays are not sensitive to the input polarization state of the illumination light, which provides an additional advantage. Finally, due to its scalability, it can drive the development of multispectral imagers at any part of the electromagnetic spectrum, which would be especially important for bands where high-density and large-format spectral filter arrays are not widely available or too costly.

In one embodiment, a diffractive optical network for performing multispectral imaging includes a one or more optically transmissive and/or reflective layers arranged in one or more optical paths, each of the one or more optically transmissive and/or reflective layers having a plurality of physical features located in different locations in each of the one or more layers of the diffractive optical network and having different valued transmission and/or reflection parameters as a function of lateral coordinates across each layer, wherein the one or more optically transmissive and/or reflective layers and the plurality of physical features collectively receive illumination light from the one or more objects and generate a filtered image of the one or more objects at an output plane with a virtual spectral filter array that includes periodically repeating cells located at the output plane, wherein each periodically repeating cell has one or more members that capture at least one wavelength or at least one wavelength range or band. A monochrome image sensor or an opto-electronic detector is located at the output plane and positioned to capture a spectrally filtered image of the one or more objects by the virtual spectral filter array.

In another embodiment, a diffractive optical network for performing multispectral imaging includes one or more optically transmissive and/or reflective layers arranged in one or more optical paths and configured to receive an input image, each of the one or more optically transmissive and/or reflective layers including a plurality of physical features located in different locations in each of the one or more layers of the network and having different valued transmission and/or reflection parameters as a function of lateral coordinates across each layer, wherein the one or more optically transmissive and/or reflective layers and the plurality of physical features collectively receive the input image and generate a spectrally filtered image of the input image at an output plane with a virtual spectral filter array including periodically repeating cells located at the output plane, wherein each periodically repeating cell has one or more members capturing at least one wavelength or at least one wavelength range or band. The diffractive optical network further includes a monochrome image sensor or an opto-electronic detector located at the output plane and positioned to capture the spectrally filtered image by the virtual spectral filter array.

In another embodiment, a method of multispectral imaging one or more objects or an input image includes the operations of: providing a diffractive optical network that includes one or more optically transmissive and/or reflective layers arranged in one or more optical paths, each of the one or more optically transmissive and/or reflective layers having a plurality of physical features located in different locations in each of the one or more layers of the network and having different valued transmission and/or reflection parameters as a function of lateral coordinates across each layer, wherein the one or more optically transmissive and/or reflective layers and the plurality of physical features collectively receive multispectral light from the one or more objects or an input image and generate a spectrally filtered image of the one or more objects or the input image at an output plane with a virtual spectral filter array including periodically repeating cells located at the output plane wherein each periodically repeating cell has one or more members capturing at least one wavelength or at least one wavelength range or band; and a monochrome image sensor or an opto-electronic detector located at the output plane and positioned to capture the spectrally filtered image of the one or more objects or input image. The method further involves inputting the multispectral light from the one or more objects or the input image to the diffractive optical network; capturing the spectrally filtered image of the one or more objects or the input image with the monochrome image sensor or the opto-electronic detector; and generating a demosaiced image cube of the spectrally filtered image of the one or more objects or the input image. Individual spectral images or slices of the demosaiced image cube can then be displayed, viewed, or accessed.

### BRIEF DESCRIPTION OF THE DRAWINGS

FIG. 1A schematically illustrates a diffractive multispectral imager that includes a diffractive optical network for performing multispectral imaging. This embodiment illustrates illumination light of an object passing along an optical path (dashed line) that includes the layers. The layers produce a virtual spectral filter array at the output plane which is captured by the image sensor. The spectrally filtered output image(s) are subject to demosaicing which generates the demosaiced image cube which is then used to obtain individual multispectral images.

FIG. 1B schematically illustrates a diffractive multispectral imager that includes a diffractive optical network for performing multispectral imaging. This embodiment illustrates an image generated by a lens-based imaging device being input along an optical path (dashed line) of the diffractive optical network that includes the layers. The layers produce a virtual spectral filter array at the output plane which is captured by the image sensor. The spectrally filtered output image(s) are subject to demosaicing which generates the demosaiced image cube which is then used to obtain individual multispectral images.

FIG. 2 illustrates one embodiment of a virtual spectral filter array (3×3) along with the image sensor which is used to capture the spectrally filtered images.

FIG. 3 illustrates a flowchart of the operations or processes used to train a digital representation or model of the diffractive optical network used to perform multispectral imaging according to one embodiment. Following training of the digital model of the diffractive optical network, the physical embodiment of the diffractive optical network is formed and paired with an image sensor or opto-electronic detector that is used in the diffractive multispectral imager.

FIG. 4 illustrates an example of a layer used in the diffractive optical network.

FIG. 5 illustrates a schematic of a diffractive multispectral imager. The depicted diffractive optical network simultaneously performs coherent optical imaging and spectral routing/filtering to achieve multispectral imaging by creating a periodic virtual filter array at the output. In this example, 3×3=9 spectral bands per virtual filter array are illustrated. In alternative implementations, the diffractive multispectral network can also be placed behind the image plane of a camera (before the image sensor), transferring the multispectral image of an object onto the plane of a monochrome image sensor such as seen in FIG. 1B.

FIGS. 6A-6D illustrate the performance of a diffractive multispectral imager with N_{B}=9 spectral bands. FIG. 6A illustrates the material thickness distribution of the diffractive layers trained using deep learning to spatially separate nine (9) distinct spectral bands, creating a periodic virtual filter array. FIG. 6B illustrates the cross-talk image matrix showing the output images at different illumination wavelengths. Off-diagonal images indicate that the level of spectral cross-talk is minimal. By summing up all the images in each column, the impact of the spectral cross-talk from the other eight (8) spectral channels on each target wavelength is visualized at the bottom of the image matrix, as a separate row. FIG. 6C illustrates the output optical power distribution as a function of the illumination wavelength. Each row in this matrix adds up to 100%, and the off-diagonal optical power percentages indicate the level of spectral cross-talk between different bands. FIG. 6D is a graph of the SSIM and PSNR values of the resulting images at the output of the diffractive network; these image quality metrics were calculated between the diagonal images shown in FIG. 6B (the ground truth images on the left diagonal vs. the diffractive network output images on the right diagonal).

FIGS. 7A-7C illustrate the spectral responsivity and power efficiency achieved by the diffractive multispectral imager shown in FIG. 6A (N_{B}=9). FIG. 7A illustrates the virtual spectral filter array periodically repeats at the output field of view of the diffractive network. The labels, Sᵢ, i=1, 2, 3, . . . , 9, denote the virtual pixels assigned to the wavelength λᵢ. FIG. 7B shows the average normalized spectral response of the virtual filter array. FIG. 7C is a graph of the wavelength-dependent transmission power efficiency of the virtual filter array created by the diffractive optical network.

FIGS. 8A-8D illustrate the performance of a diffractive multispectral imager with N_{B}=16 spectral bands. FIG. 8A shows the material thickness distribution of the diffractive layers trained using deep learning to spatially separate sixteen (16) distinct spectral bands, creating a periodic virtual filter array. FIG. 8B illustrates a cross-talk image matrix showing the output images at different illumination wavelengths. Off-diagonal images indicate that the level of spectral cross-talk is minimal. By summing up all the images in each column, the impact of the spectral cross-talk from the other fifteen (15) spectral channels on each target wavelength is visualized at the bottom of the image matrix, as a separate row. FIG. 8C illustrates the output optical power distribution as a function of the illumination wavelength. Each row in this matrix adds up to 100%, and the off-diagonal optical power percentages indicate the level of spectral cross-talk between different bands. FIG. 8F is a graph of the SSIM and PSNR values of the resulting images at the output of the diffractive network; these image quality metrics were calculated between the diagonal images shown in FIG. 8B (the ground truth images on the left diagonal vs. the diffractive network output images on the right diagonal).

FIGS. 9A-9C illustrate the spectral responsivity and power efficiency achieved by the diffractive multispectral imager shown in FIG. 8A (N_{B}=16). FIG. 9A illustrates the virtual spectral filter array periodically repeats at the output field of view of the diffractive network. The labels, Sᵢ, i=1, 2, 3, . . . , 16, denote the virtual pixels assigned to the wavelength λᵢ. FIG. 9B illustrates the average normalized spectral response of the virtual filter array. FIG. 9C is a graph of the wavelength-dependent transmission power efficiency of the virtual filter array created by the diffractive optical network.

FIGS. 10A-10C illustrate the experimental setup of the multispectral terahertz imager (N_{B}=4). FIG. 10A is a schematic of the experimental setup using terahertz illumination and signal detection. FIG. 10B shows the optical design layout of the fabricated diffractive multispectral imager and the material thickness profiles of the three (3) diffractive surfaces. FIG. 10C illustrates the fabricated diffractive optical network and the input object, the letter ‘U’.

FIGS. 11A-11D illustrate the experimental results for the diffractive multispectral imager shown in FIG. 10C. Multispectral imaging of letter ‘U’ at four (4) distinct wavelengths in terahertz part of the spectrum based on the 3-layer diffractive optical network shown in FIG. 10C. FIG. 11A illustrates the multispectral image cube synthesized by the numerical forward model of the diffractive optical network, after the demosaicing step. FIG. 10B is the same as FIG. 10A, except that the images are extracted from the experimentally measured output optical intensity profiles. FIG. 10C is the cross-talk matrix predicted by the numerical forward model of the diffractive multispectral imager in response to the input object ‘U’. FIG. 10D is the same as FIG. 10C, except that the entries in the cross-talk matrix represent the experimentally measured percentages of the optical power for each spectral band.

FIGS. 12A-12D illustrate the impact of the number of diffractive features (N) and the targeted spectral bands (N_{B}) on the quality of the multispectral imaging using a diffractive optical network. Mean SSIM and PNSR values as a function of N are reported for FIG. 12A N_{B}=4, FIG. 12B N_{B}=9, FIG. 12C N_{B}=16 spectral channels, forming a spatially repeating virtual spectral filter array. FIG. 12D illustrates the impact of N_{B} on the SSIM of the output multispectral images for different diffractive network architectures. K refers to the number of successive diffractive layers jointly trained for multispectral imaging, and N_{L} refers to the number of trainable diffractive features per diffractive layer.

FIG. 13 illustrates a graph showing the trade-off between the multispectral imaging quality and the virtual filter array power transmission efficiency. The impact of the additional power efficiency-related penalty term, [symbol] ₑ and its weight γ, on the multispectral image cube synthesized by the diffractive multispectral imagers that were trained to form 3×3 virtual spectral filter arrays assigned to N_{B}=9 unique spectral bands within the visible spectrum. The optical architectures of these diffractive multispectral imagers are identical to the layout depicted in FIG. 5. An average virtual filter transmission efficiency of >79% is reported across N_{B}=9 spectral bands with a minimal penalty on the output image quality.

FIGS. 14A-14C illustrate the performance of a diffractive multispectral imager with N_{B}=4 spectral bands. FIGS. 10A-14C are the same as FIGS. 6B-6D, except for N_{B}=4.

### DETAILED DESCRIPTION OF ILLUSTRATED EMBODIMENTS

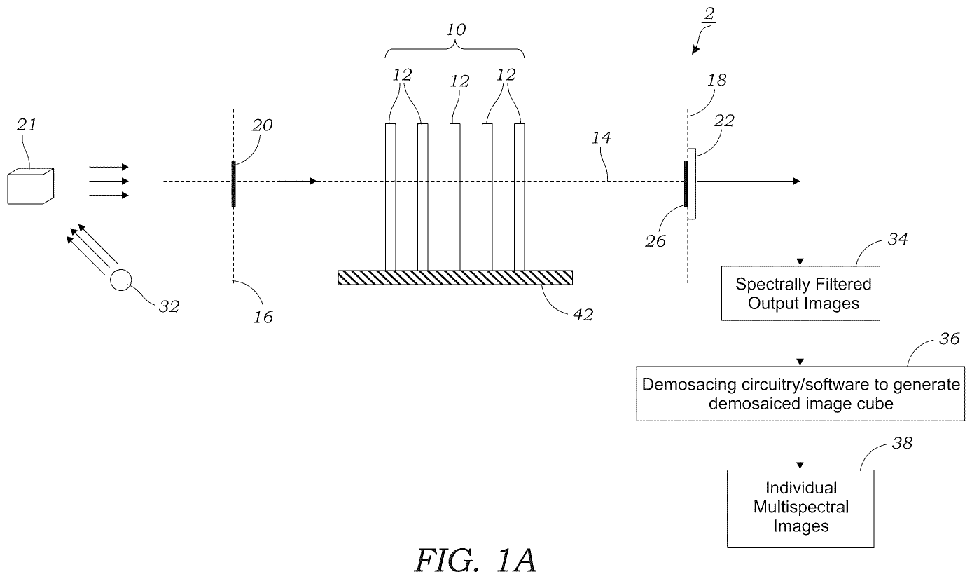

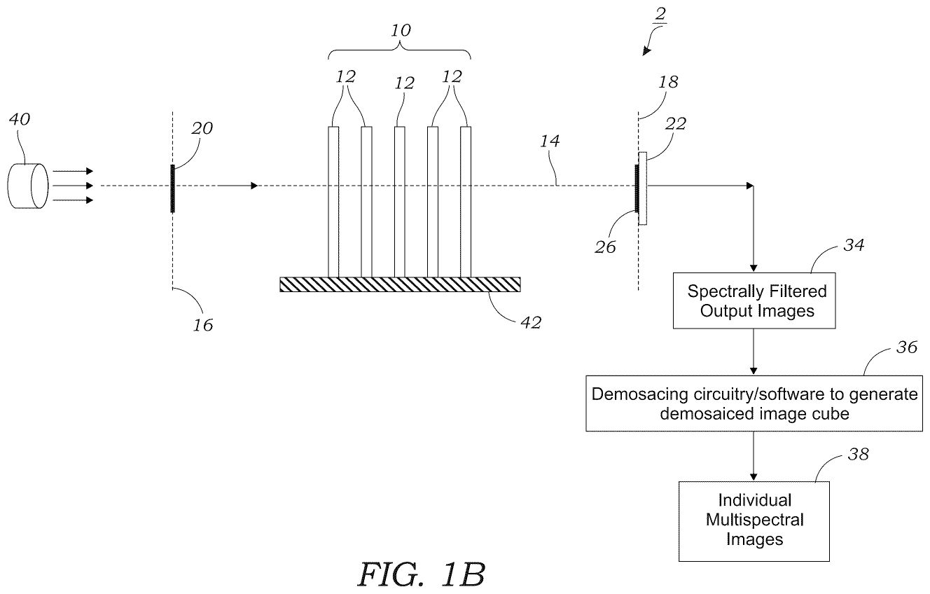

FIGS. 1A and 1B illustrate a diffractive multispectral imager 2 that uses a diffractive optical network 10 for performing multispectral imaging (e.g., diffractive networks or D²NNs) includes one or more layers 12 arranged along an optical path 14. The optical path 14 extends between an input or image plane 16 and an output plane 18. The optical path 14 may be straight as illustrated or folded. The input or image plane 16 contains an input image 20 that is to be input to the diffractive optical network 10. The input image 20 may include an image of one or more objects 21 such as illustrated in FIG. 1A. Natural or artificial light may illuminate the one or more objects 21 (e.g., through reflection and/or transmission) at a plurality of wavelengths. This may include a number of discrete wavelengths or wavelength ranges or a spectrum that includes a larger band of wavelengths. The input image 20 may also include an image that is captured by an optical device 40 such as a camera or other imager that is then input into the diffractive multispectral imager 2 as illustrated in FIG. 1B. An image sensor or an opto-electronic detector 22 is positioned within the optical path 14 at the output plane 18.

When a plurality of diffractive layers 12 are used such as illustrated in FIGS. 1A and 1B, the diffractive layers 12 are spaced apart from one another. In one embodiment, the one or more layers 12 are transmissive to light whereby light diffracts as it passes through the various layer(s) 12 and interacts with physical features 24 located in the layer(s) 12 that act either individually or collectively as “neurons” of the diffractive optical network 10. In other embodiments, the layer(s) 12 may include reflective layer(s) 12 where light reflects of the surface(s) thereof. Each layer 12 of the diffractive optical network 10 has a plurality of physical features 24 (FIG. 4) formed on the surface of the layer 12 or within the layer 12 itself that collectively define a pattern of physical locations along the length and width of each layer 12 that have varied transmission parameters/coefficients (or varied reflection parameters/coefficients for a reflection embodiment). The physical features 24 formed on or in the layer(s) 12 thus create a pattern of physical locations within the layer(s) 12 that have different transmission properties as a function of local coordinates (e.g., length and width and in some embodiments depth) across each layer 12. In some embodiments, each separate physical feature 24 may define a discrete physical location on the layer 12 while in other embodiments, multiple physical features 24 may combine or collectively define a physical region with a particular transmission parameter or coefficient. These physical features 24 or collections of such physical features 24 form the optical “neurons” of the diffractive optical network 10 that are analogous to the neurons in electronic neural networks.

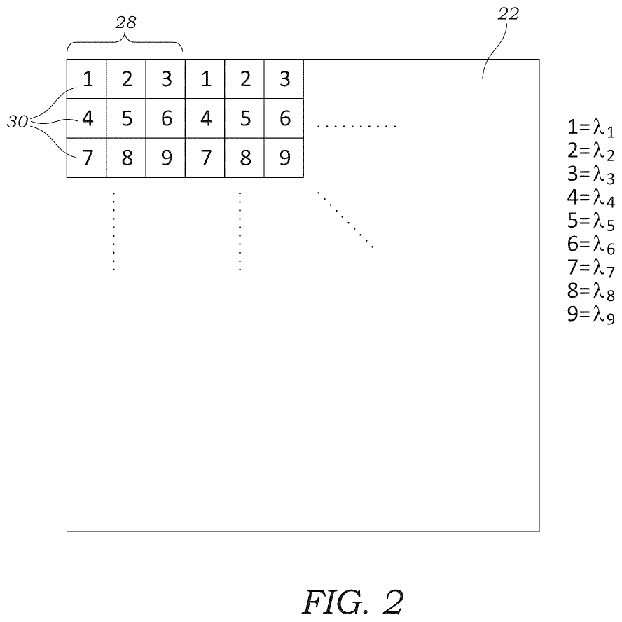

The one or more layers 12 are arranged along the optical path 14 (dashed line in FIGS. 1A and 1B) and collectively generate a virtual spectral filter array 26 at the output plane 18. The virtual spectral filter array 26 spatially separates the input spectral channels from the illumination source into distinct pixels of the image sensor 22 at the same output image plane 18, serving as a virtual spectral filter array 26 that preserves the spatial information of the object/input image 20. As best seen in FIG. 2, the virtual spectral filter array 26 has periodically repeating cells 28 located at the output plane 18 that capture at least one wavelength or at least one wavelength range or band. Each periodically repeating cell 28 has one or more members 30 within a cell 28 capturing at least one wavelength or at least one wavelength range or band. Each member 30 of the repeating cells 30 of the virtual spectral filter array 26 has a distinct spectral filter function that passes one or more wavelengths or wavelength ranges or bands. The filter function of the particular member 30 of the repeating cell 28 refers to its transmission as a function of wavelength and can be any function. In one embodiment, a repeating cell 28 captures multiple wavelengths or wavelength ranges with multiple members 30. In another embodiment, however, a cell 28 captures a single wavelength or wavelength range or band (i.e., one member 30). FIG. 2 illustrates a cell 28 that contains nine (9) members 30, each member 30 associated with a particular wavelength or wavelength range/band (e.g., λ₁, λ₂, λ₃, λ₄, λ₅, λ₆, λ₇, λ₈, λ₉).

FIGS. 2, 7A, and 9A illustrate embodiments of the repeating cell 28 capturing multiple wavelengths (e.g., 9 or 16 channels or members 30). The single cell 28 may be arranged in an array as illustrated although other configurations are contemplated. The virtual spectral filter array 26 may be ordered (e.g., in a repeating pattern) or disordered (arranged in a random but known manner). Each cell 28 of the virtual spectral filter array 26 corresponds to a different area or region of the image sensor or opto-electronic detector 22. Thus, different pixels of the image sensor or opto-electronic detector 22 capture different optical signals from the cells 28 that define the virtual spectral filter array 26. The result is that the raw output image 34 captured by the image sensor or opto-electronic detector 22 is a mosaic or checkerboard-type image of the objects or the input image 20.

With reference to FIGS. 1A, 5, and 10A, in some embodiments, an illumination light source 32 illuminates a sample and/or object(s) 21 with multispectral illumination light. This may be light at a plurality of wavelengths or wavelength ranges or bands or broadband light that extends across a range of wavelengths. The light may be spatially-coherent light or spatially-incoherent light in another embodiment. The light source 32 may include a natural light source (e.g., sunlight or radiation emitted by the object) or the light source 32 may be an external light source such as a from a light or multiple lights or other light sources. The light passes through (or reflects off the sample/objects 21) and passes through the layers 16 of the diffractive optical network 10. The layers 16, as noted herein, are used to create a virtual spectral filter array 26 that spatially separates the input spectral channels into repeating cells 28 that capture one or more wavelengths or wavelength ranges or bands of the illumination light source 32. The spectrally filtered output images 34 which appear, in one embodiment, as a checkerboard-type image, is then subject to a demosaicing operation to generate the multispectral images. The demosaicing operation generates a demosaiced image cube 36 from the spectrally filtered output images 34. Each member (or slice) of the demosaiced image cube 36 refers to one spectrally filtered image obtained by that particular member 30 of the repeating cell 28. The final spectral images 38 or slices of the generated demosaiced image cube 36 can then be displayed, viewed or accessed.

The demosaicing operation may be performed using dedicated circuitry or through software. Demosaicing of images is a well-known operation and various hardware or software-based methods may be employed. It should be appreciated that the different wavelengths captured by the image sensor or opto-electronic detector 22 and the virtual spectral filter array 26 created by the diffractive optical network 10 may be illuminated simultaneously or sequentially. The illumination light source 32 may illuminate the sample and/or objects with illumination in any part of the electromagnetic spectrum.

As an alternative configuration, instead of illumining a sample and/or objects with an illumination source 32, an input image 20 of a sample and/or objects is projected into the diffractive optical network 10. For example, a lens-based imaging device 40 may be used to generate or project an input image 20 at the image plane (input) of the diffractive optical network 10.

The image sensor or opto-electronic detector 22 is preferably, in one embodiment, an imaging chip such as a CMOS image sensor. However, optical detectors arranged in an array similar to the pixels in an image sensor may also be used. For example, an opto-electronic detector 22 may be used instead of an imaging chip such as a CMOS image sensor. The image sensor 22 is a monochrome image sensor in one preferred embodiment. Thus, the diffractive optical network 10 is able to convert an existing monochrome imaging system into a multispectral imager. For example, the diffractive optical network 10 could be interposed between the image plane of a camera and a monochrome focal plane array or image sessor 22.

With reference to FIG. 4, the pattern of physical locations formed by the physical features 24 may define, in some embodiments, an array located across the surface of the layer(s) 12. The layer 12, in one embodiment, is a two-dimensional generally planer substrate having a length (L), width (W), and thickness (t) that all may vary depending on the particular application. In other embodiments, the layer(s) 12 may be non-planer. The local lateral coordinates of the physical features 24 and the physical regions formed thereby act as artificial “neurons” within the layer(s) 12 that connect to other “neurons” of other layer(s) 12 of the diffractive optical network 10 and alter the phase and/or amplitude of the light wave that passes through the layer 12 (or reflects of the layer 12 if a reflective layer). The particular number and density of the physical features 24 or artificial neurons that are formed in each layer 12 may vary depending on the type of application. In some embodiments, the total number of artificial neurons may only need to be in the hundreds or thousands while in other embodiments, hundreds of thousands or millions of neurons or more may be used.

Likewise, the number of layers 12 that are used in a particular diffractive optical network 10 may vary although it typically ranges from at least one layer 12 to less than ten layers 12 (although additional layers beyond this range are contemplated). As described herein, in one embodiment, the various neurons are formed by physical features 24 of differing the thickness of layer(s) 12. In one embodiment, the different thicknesses (t) of the physical features 24 modulate the phase of the light passing through the layer 12. This type of physical feature 24 may be used, for instance, in the transmission mode embodiment. The different thicknesses of material in the layer 12 forms a plurality of discrete “peaks” and “valleys” that control the transmission parameters/coefficients of the neurons formed in the layer 12. The different thicknesses of the layer 12 may be formed using additive manufacturing techniques (e.g., 3D printing) or lithographic methods utilized in semiconductor processing. This includes well-known wet and dry etching processes that can form very small lithographic features on a substrate. Lithographic methods may be used to form very small and dense physical features on the layer 12 which may be used with shorter wavelengths of the light.

Alternatively, the transmission function of a neuron can also be engineered by using metamaterial or plasmonic structures as the physical features 24. Combinations of all these techniques may also be used. In other embodiments, non-passive components may be incorporated in into the layer(s) 12 such as spatial light modulators (SLMs). SLMs are devices that imposes spatial varying modulation of the phase, amplitude, or polarization of a light. One or more of these SLMs may be incorporated in the layer(s) 12. SLMs may include optically addressed SLMs and electrically addressed SLM. Electric SLMs include liquid crystal-based technologies that are switched by using thin-film transistors (for transmission applications) or silicon backplanes (for reflective applications). Another example of an electric SLM includes magneto-optic devices that use pixelated crystals of aluminum garnet switched by an array of magnetic coils using the magneto-optical effect. Additional electronic SLMs include devices that use nanofabricated deformable or moveable mirrors that are electrostatically controlled to selectively deflect light. Thus, in some embodiments, the physical properties of the layers 12 may be adjusted or tuned as a function of time.

The particular spacing of the layers 12 that make the diffractive optical network 10 may be maintained using a holder 42 like that illustrated in FIGS. 1A and 1B. The holder 42 may contact one or more peripheral surfaces of the layer(s) 12. In some embodiments, the holder 42 may contain a number of slots that provide the ability of the user to adjust the spacing between adjacent layers 12. A single holder 42 can thus be used to hold different diffractive optical networks 10. In some embodiments, the layers 12 may be permanently secured to the holder 42 while in other embodiments, the layers 12 may be removable from the holder 42 and replaceable. For example, on or more layers 12 may be removed/added to the holder 42 to create different diffractive optical networks 10 or to tune/alter the performance of the diffractive optical network 10.

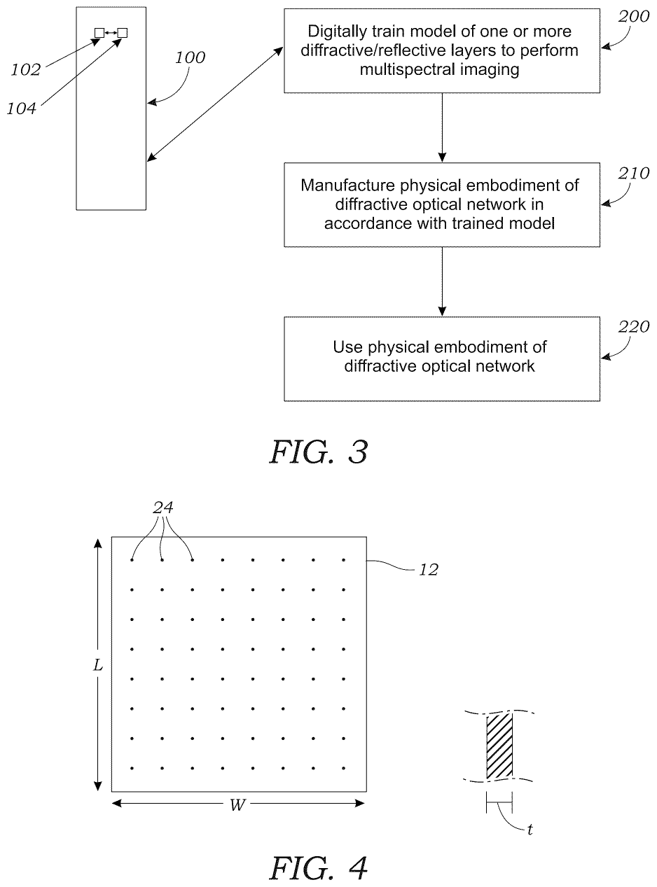

As explained herein, the design or physical embodiment of the diffractive optical network 10 is able to perform multispectral imaging. FIG. 3 illustrates a flowchart of the operations or processes according to one embodiment to create and use a diffractive optical network 10 for performing multispectral imaging. As seen in operation 200, at least one computing device 100 having one or more processors 102 executes software 104 thereon to then digitally train a model or mathematical representation of layers 12 to generate the desired virtual spectral filter array 26 at the output plane 18. In this digital training operation 200, a set of layers 12 are trained using deep learning to all-optically generate multispectral images of different objects or input images. Once the design has been established that creates the physical layout for the different physical features 24 that form the artificial neurons in each of the plurality of layers 12 which are present in the diffractive optical network 10, the physical embodiment is then manufactured or fabricated that reflects the computer-derived design. This is illustrated in operation 210 of FIG. 3. The design, in some embodiments, may be embodied in a software format (e.g., SolidWorks, AutoCAD, Inventor, or other computer-aided design (CAD) program or lithographic software program) may then be manufactured into a physical embodiment that includes the plurality of layers 12 as well as the respective spacings between the layers 12. The one or more layers 12, once manufactured may be mounted or disposed in a holder 42. The holder 42 may include a number of slots formed therein to hold the layers 12 in the required sequence and with the required spacing between adjacent layers 12 (if needed). Once the physical embodiment of the diffractive optical network 10 has been made, the diffractive optical network 10 is then used to perform multispectral imaging. For example, the diffractive optical network 10 with the one or more layers 12 is provided in the optical path 14 that receives the light from object(s) or an input image. The image sensor or opto-electronic detector 22 is placed at the output plane 18 to capture the raw images from the virtual spectral filter array 26. Use of the physical embodiment is seen in operation 220 in FIG. 3.

### Results

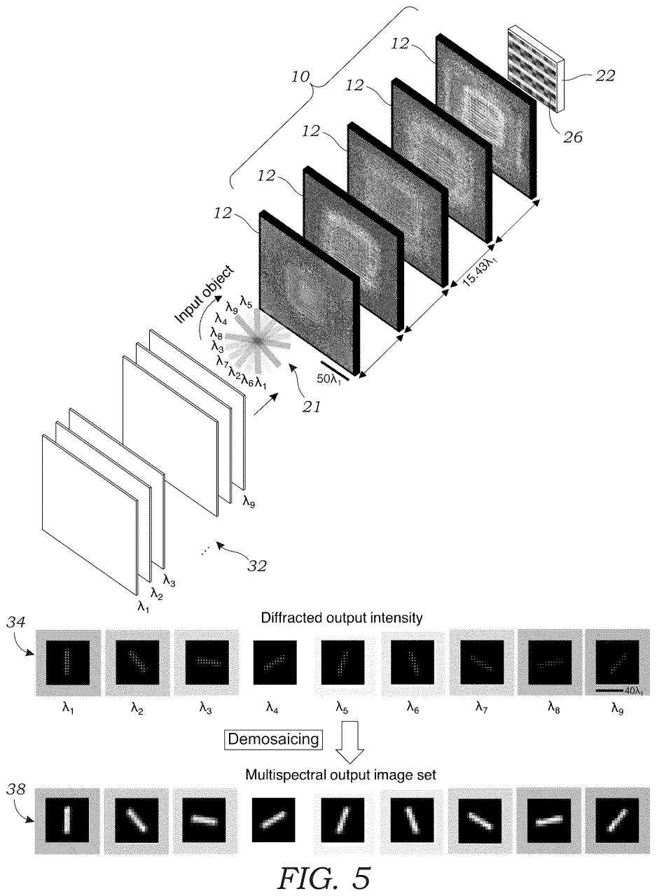

FIG. 5 depicts the optical layout and the forward model of a 5-layer diffractive multispectral imager that uses the diffractive optical network 10 that can spatially separate N_{B} distinct spectral bands into a virtual spectral filter array 26 on a monochrome image sensor 22 located at the output image plane 18; in this illustration of FIG. 5, N_{B}=9 is shown as an example, although it can be further increased, as will be reported below. The input FOV in FIG. 5 exemplifies a hypothetical object where the amplitude channel of the object's light transmission is composed of intersecting lines, and each line strictly transmits only one wavelength. The multispectral imaging diffractive optical network 10 aims to spatially separate the optical signal carried by each wavelength component on the output sensor plane 18 so that a demosaicing operation would reveal the wavelength-dependent images of the input object 21. Such a forward optical transformation can be defined using a linear spatial mapping (y=x) between the input intensity describing the amplitude transmission properties of the input object 21 at a given wavelength and the corresponding monochromatic pixels of the image sensor 22 assigned to that targeted spectral band. This indicates that for a diffractive network-based spatially-coherent multispectral imager, there is a phase degree of freedom at the output image plane 18, making it easier to learn the desired multispectral imaging task through, e.g., deep learning. For a diffractive multispectral imager using the diffractive optical network 10 as shown in FIG. 5, Nᵢ and Nₒ indicate the number of effective pixels at the input and output FOVs, respectively, which are dictated by the extent of the input and output FOVs along with the desired spatial resolution (within the diffraction limit). The number of spectral channels (N_{B}) as part of the targeted multispectral imaging design depends on the cross-talk among different spectral bands of the virtual spectral filter array 26 created at the diffractive network output plane 18, which is quantified in the analysis reported below. Although not demonstrated here, in alternative implementations, the diffractive optical network 10 can also be placed right behind the image plane of a camera, transferring the multispectral image of an object onto the plane of the monochrome focal plane array, converting an existing monochrome imaging system into a diffractive multispectral imager 2.

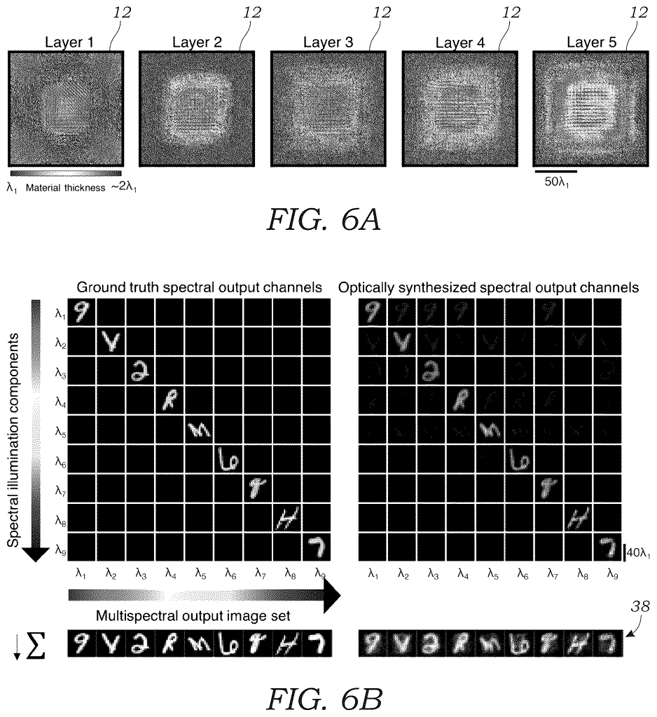

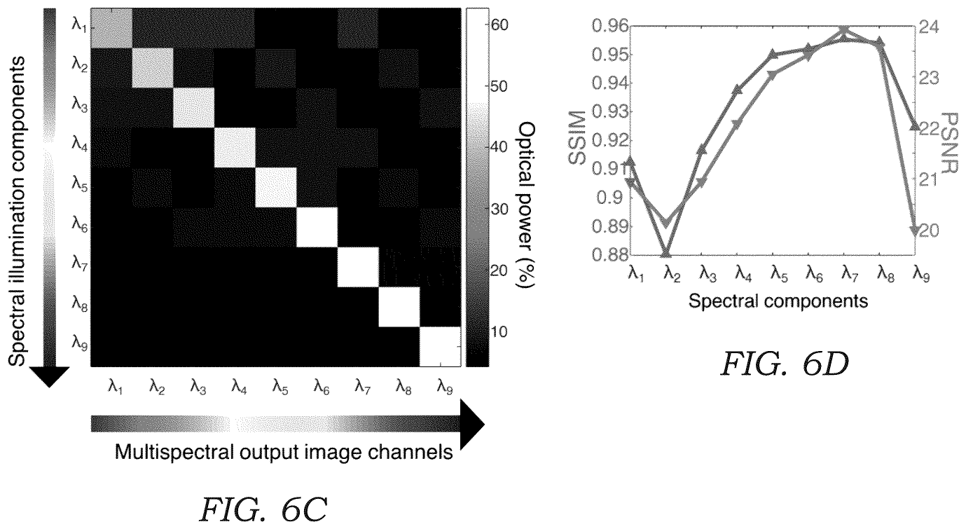

To train (and design) the electronic version of the diffractive multispectral imager 2, input objects were created, where the transmission field amplitude of a given object at each spectral band was represented by an image randomly selected from the 101.6K training images of the EMNIST dataset (see the Methods section). The phase profiles of the five diffractive layers 12 (containing ~0.76 million trainable diffractive features in total) were optimized through the error-backpropagation and stochastic gradient descent using a loss function based on the spatial mean-squared error (MSE) that includes all the desired spectral channels; see the Methods section. This deep learning-based optimization used 100 epochs, where the ground truth multispectral output images were generated using the EMNIST dataset randomly assigned to different spectral bands of interest. FIG. 6A illustrates the resulting material thickness profiles of a K=5 layer diffractive multispectral imager 2 trained to operate within the visible spectrum, evenly covering the wavelength range from λ₉=450 nm to λ₁=700 nm based on the optical layout shown in FIG. 5, i.e., λ₉<λ₈< . . . <λ₁. For simplicity and without loss of generality, it was assumed that the input light spectrum lies between 450 nm and 700 nm; modern CMOS image sensors 22 cover a slightly wider bandwidth than considered here. The forward optical training model of this diffractive optical network 10 assumes a monochrome image sensor 22 at the output plane 18 with a pixel size of 0.9 μm×0.9 μm (~1.28λ₁×1.28λ₁), which is typical for today's CMOS image sensor technology widely deployed in, e.g., smartphone cameras. This diffractive design spatially extends ~43 μm in the axial direction along the optical path 14 (from the first diffractive layer 12 to the last layer 12), and is optimized to route N_{B}=9 distinct spectral lines (i.e., 700 nm, 668.75 nm, 637.5 nm, 606.25 nm, 575 nm, 543.75 nm, 512.5 nm, 481.25 nm, and 450 nm) onto a 3×3 monochrome sensor pixel-array, that is repeating in space for snapshot multispectral imaging without any digital image reconstruction algorithm. Without loss of generality, unit magnification was assumed between the object/input FOV and the monochrome image sensor plane (output FOV); hence, the size of the smallest feature size of the input images was set to be 3×0.9 μm, i.e., equal to the width of a virtual spectral filter array (3×3).

Following the deep learning-based training and design phase (see the Methods section for further details), a multicolor image test set with a total of 2080 distinct objects (never seen during the training) was used to quantify the multispectral imaging performance of the trained diffractive network design. For each object in the blind test set, the field amplitude of the object transmission function at each spectral band was modeled based on an image randomly selected from the test dataset. An example of the imaging results corresponding to a multispectral test object never used during the training is shown in FIG. 6B. Based on the checkerboard-like output intensity patterns synthesized by the diffractive multispectral imager in response to the 2080 different test objects, the spectral image contrast of the diffractive network output can be quantified as shown in FIG. 6C; each row of the matrix in FIG. 6C corresponds to a different illumination wavelength and all the rows sum up to 100% (optical power). Hence, the rows of this matrix represent the percentage of the output optical power that resides within the designated group of virtual pixels for a given wavelength channel, calculated as an average of all the 2080 blind test objects. The columns of the matrix in FIG. 6C, on the other hand, illustrate the signal contrast and the spectral leakage over a given array of virtual spectral filters assigned to a spectral band. Analyses shows that for a given set of virtual spectral pixels assigned to a particular spectral band (a column of the matrix in FIG. 6C), the power of the desired signal band is on average (8.57±1.59)-fold larger compared to the mean power of the other spectral bands (leakage) collected by the same array of virtual spectral filter pixels.

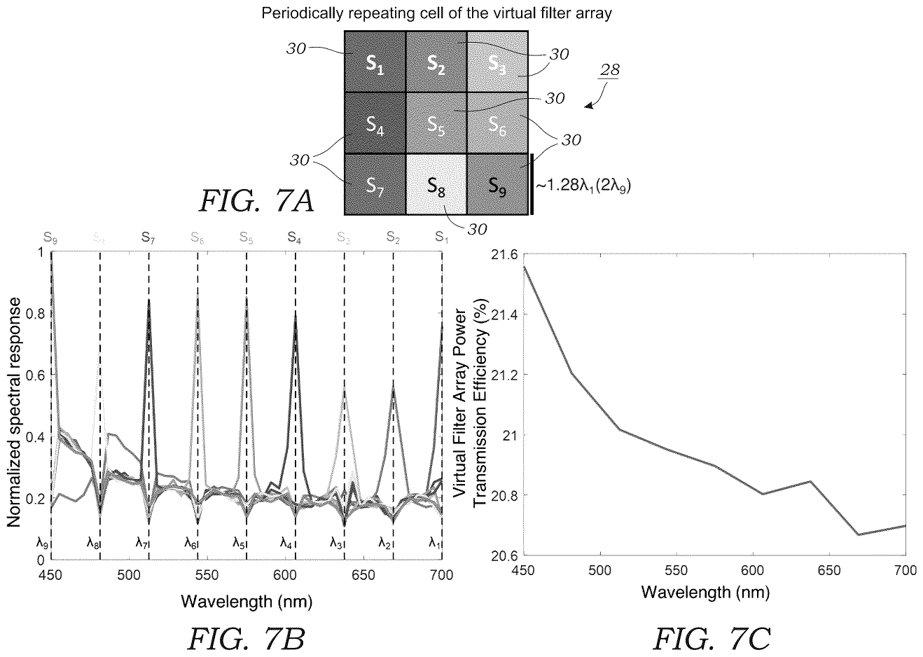

Based on the data shown in FIG. 6C, one can see that the performance of the diffractive multispectral imager 2 is inversely proportional to the wavelength. In other words, the diffractive optical network 10 designed using deep learning can route smaller wavelengths onto their corresponding virtual spectral filter array 26 locations better than larger wavelengths. A similar conclusion can also be observed in the spectral responsibility curves of the 3×3 virtual spectral filter array 26, periodically assigned to N_{B}=9 (see FIG. 7B); the responsivity curves of these virtual spectral filter arrays 26 get narrower as the wavelength gets smaller, with the narrowest filter response achieved for λ₉=450 nm. These observations can be explained based on the degrees of freedom available at each wavelength: due to the diffraction limit of light, the effective number of trainable diffractive features seen/controlled by larger wavelengths is smaller than the total number of trainable features within the entire diffractive network, N=5×392×392. For example, a given diffractive layer depicted in FIG. 6A contains N_{L}=392×392 diffractive features, each with a size 225 nm×225 nm, i.e., λ₉/2×λ₉/2, which also corresponds to λ₁/3.11×λ₁/3.11. Considering that the diffractive optical network 10 operates based on traveling/propagating waves, the longer wavelengths experience reduced degrees of freedom due to the diffraction limit of light, which restricts the independent (useful) feature size on a diffractive layer 12 to half of the wavelength in each spectral band.

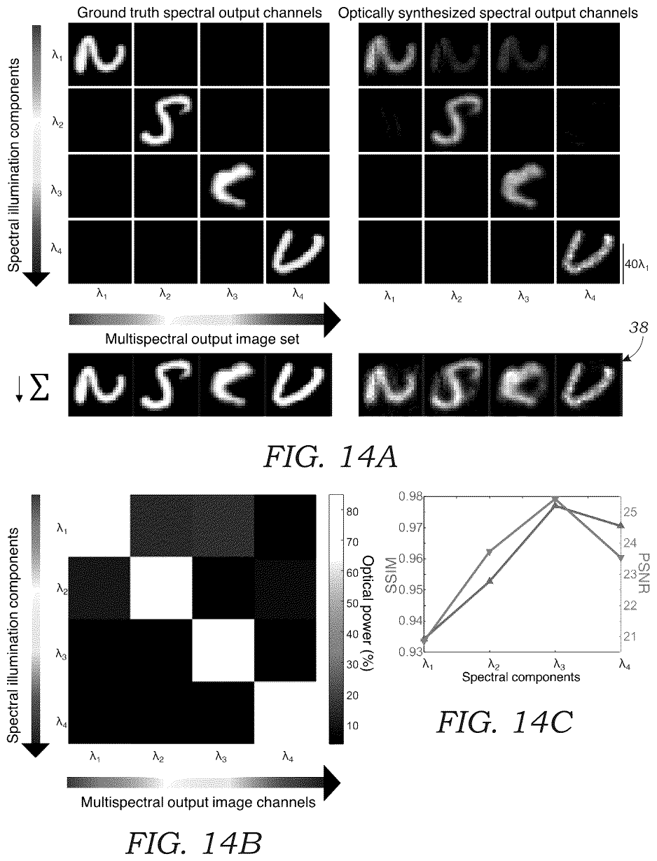

Next, the multispectral imaging quality provided by the diffractive optical network 10 design shown in FIG. 6A was quantified using two additional performance metrics: Structural Similarity Index Measure (SSIM) and Peak Signal-to-Noise Ratio (PSNR). FIG. 6D illustrates the average SSIM and PSNR values achieved by the diffractive optical network 10 as a function of the desired spectral bands. These image quality metrics were calculated between the diagonal images shown in FIG. 6B (the ground truth images on the left diagonal vs. the diffractive optical network output images on the right diagonal). Although there are some variations in the multispectral imaging quality of the diffractive network depending on the spectral band of the input light, the SSIM (PSNR) values have a very high lower bound (worst case performance) of 0.88 (19.8 dB). In addition, the mean SSIM and PSNR values are found as 0.93 and 22.06 dB, respectively. By summing up all the images in each column of FIG. 6B, one can create an image that visualizes the impact of the spectral cross-talk from the other N_{B}−1=8 spectral channels on each target wavelength, which is shown at the bottom of the image matrix in FIG. 6B, as a separate row. Due to this spectral power cross-talk among channels (quantified in FIG. 6C), the average values of the SSIM and PSNR of the output multispectral image cube (computed across all the bands) drop to 0.65 and 16.24 dB, respectively. FIGS. 14A-14C illustrate the cross-talk matrix and multispectral imaging performance of a diffractive multispectral imager 2 designed for N_{B}=4 spectral bands in the visible spectrum. Due to the reduced number of target spectral bands compared to the N_{B}=9 case, the spectral power cross-talk is reduced for the N_{B}=4 diffractive multispectral imager 2 as quantified in FIG. 14B; as a result, the diffractive optical network 10 can synthesize multispectral image cubes 36 with improved mean SSIM (0.82) and mean PSNR (19.29 dB) calculated across all the N_{B}=4 bands.

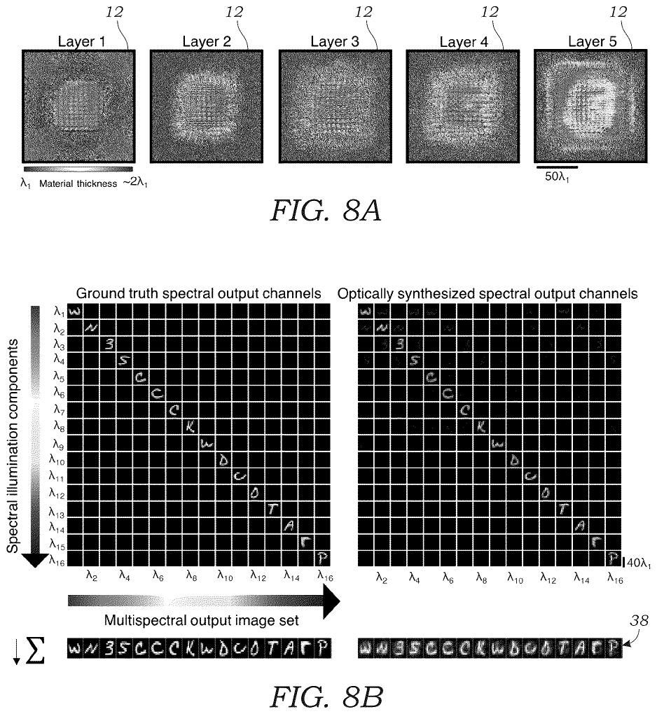

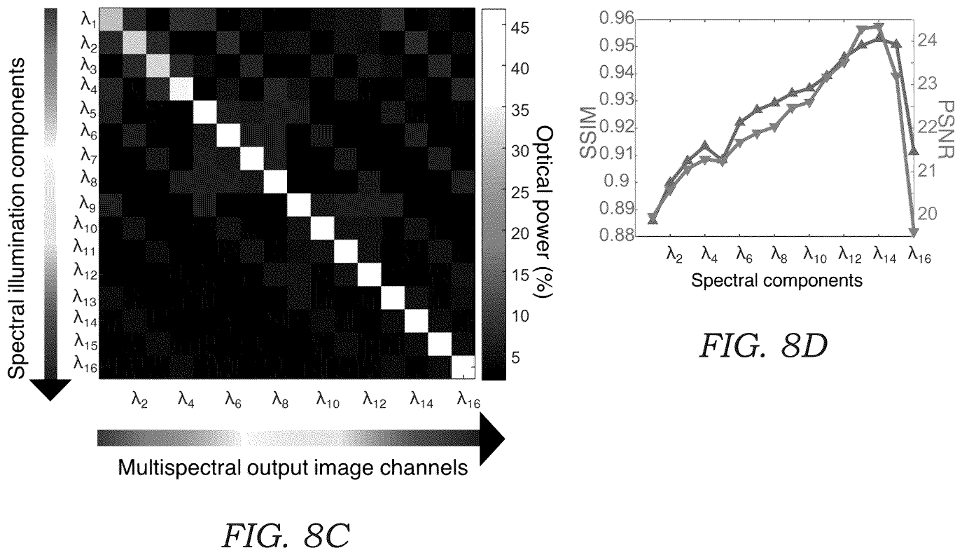

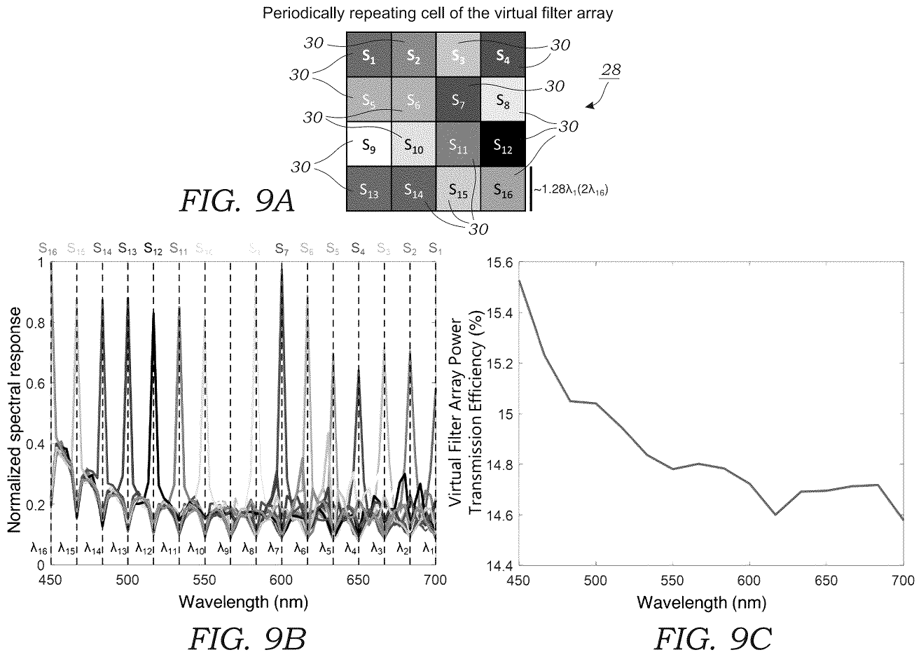

To demonstrate diffractive multispectral imaging with an increased number of spectral channels, FIG. 8A demonstrates the material thickness profiles of the diffractive layers 12 constituting a new diffractive multispectral imager 2 that was trained for N_{B}=16, evenly distributed between λ₁₆=450 nm to λ₁=700 nm, mapped onto a 4×4 monochrome pixel array repeating in space for snapshot multispectral imaging. Compared to the diffractive multispectral imager 2 depicted in FIG. 6A, this new diffractive design targets a lower spatial resolution due to the trade-off between N_{B} and the spatial resolution of the snapshot diffractive multispectral imager 2. Similar to FIG. 6B, the output images on the diagonals of the multispectral image cube 36 shown in FIG. 8B closely match the ground truth multispectral images at the input, highlighting the success of the diffractive imaging design. The off-diagonal images that are dark (see FIG. 8B) further illustrate the success of the spectral routing performed by the diffractive multispectral imager, minimizing the cross-talk among channels. FIG. 8C also illustrates the average spectral signal contrast synthesized by the diffractive optical network 10 at its output for N_{B}=16 spectral bands. Compared to the signal contrast map of the previous diffractive optical network 10 design (N_{B}=9 shown in FIG. 6C), the values in FIG. 8C point to a slight decrease in the average spectral contrast at the output of this new diffractive multispectral imager 2 with N_{B}=16. However, the output image quality of the diffractive multispectral imager 2 with N_{B}=16 is still outstanding: the output SSIM (PSNR) values have a very good lower bound of 0.88 (19.62 dB), and the mean SSIM and PSNR values are 0.92 and 22.0 dB, respectively (see FIG. 8D). Same as in FIG. 6B, these image quality metrics were calculated between the diagonal images shown in FIG. 8B (left vs. right). By summing up all the images in each column of FIG. 8B, one can create an image that visualizes the impact of the power cross-talk from the other N_{B}−1=15 spectral bands on each target wavelength, which is shown at the bottom of the image matrix in FIG. 8B, as a separate row. As a manifestation of the spectral power cross-talk quantified in FIG. 8C, the average values of SSIM and PSNR of the output multispectral image cube drop to 0.60 and 15.33 dB, respectively, calculated across all the N_{B}=16 target spectral channels. Furthermore, this diffractive multispectral imager 2 with N_{B}=16 can route the input spectral bands onto designated output pixels with an average power contrast that is 11.06× larger with respect to the mean power carried by the remaining N_{B}−1=15 spectral channels. FIG. 9B also reports the spectral responsivity curves of the 4×4 virtual spatial filter array 26 (FIG. 9A) at the output image FOV of the diffractive optical network 10. The wavelength-dependent transmission power efficiency of the virtual spectral filter array 26 created by the diffractive optical network 10 is seen in FIG. 9C.

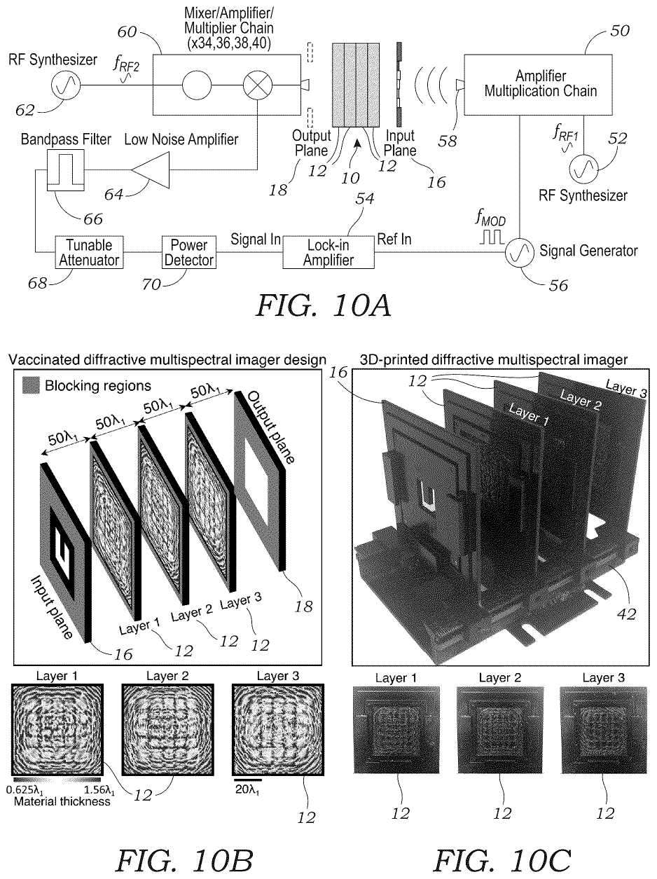

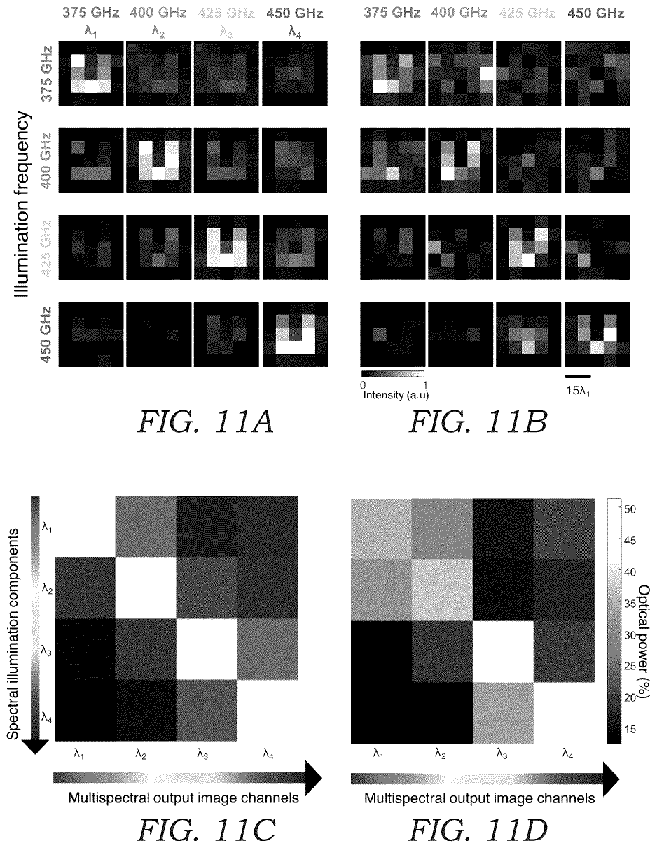

Next, to experimentally demonstrate the presented diffractive multispectral imaging framework, a physical embodiment of a diffractive multispectral imager 2 with a diffractive optical network 10 was designed that can process terahertz wavelengths. This terahertz-based diffractive multispectral imager 2 uses K=3 layers (see FIGS. 10A-10C) to form a virtual spectral filter array 26 at its output plane 18 with periodically repeating 2×2 spectral pixels targeting 0.375 THz, 0.4 THz, 0.425 THz and 0.45 THz (i. e., N_{B}=4). For the input object ‘U’ shown in FIG. 10B, the demosaiced output images predicted by the numerical forward model of the diffractive terahertz multispectral imager 2 are depicted in FIG. 11A. In the 4-by-4 image matrix shown in FIG. 11A, the diagonal images represent the correct match between the spectral content of the illumination and the corresponding demosaiced pixels within each 2×2 cell of the virtual spectral filter array 26; in other words, they represent the channels of the multispectral image cube, while the off-diagonal images show the cross-talk between different spectral bands. To quantify the performance of the diffractive multispectral imager 2, each spectral channel of the multispectral image cube 36 predicted by the numerical forward model of the diffractive terahertz multispectral imager 2 was compared with respect to the ground-truth image of the input object ‘U’, which achieved PSNR values of 15.12 dB, 14.93 dB, 15.03 dB and 13.30 dB for the spectral bands at 0.375 THz, 0.4 THz, 0.425 THz and 0.45 THz, respectively. To compare the numerical results with their experimental counterparts, FIG. 11B illustrates the experimentally measured multispectral imaging results obtained through the 3D-printed multispectral diffractive imager 2 shown in FIG. 10C, which provided a good agreement between the numerical and experimental multispectral images. Quantitative evaluation of the experimental multispectral imaging results reveals PSNR values of 13.02 dB, 13.71 dB, 13.02 dB and 12.64 dB PSNR at 0.375 THz, 0.4 THz, 0.425 THz and 0.45 THz, respectively. Compared to the numerical results, these PSNR values point to ~1-2 dB loss of image quality which can be largely attributed to the limited lateral resolution and potential misalignments of the 3D printed diffractive layers 12 in the physical embodiment of the diffractive multispectral imager 2 shown in FIG. 10C.

Beyond the multispectral image quality, the spectral cross-talk performance of the experimentally tested diffractive multispectral imager 2 was quantified. FIGS. 11C and 11D illustrate the spectral cross-talk matrices generated by the numerical forward model of the diffractive multispectral imager 2 shown in FIG. 10B and its experimentally measured counterpart using the 3D-printed diffractive multispectral imager 2 shown in FIG. 10C, respectively. For a given virtual spectral filter array 26 designated to a particular spectral band, the ratio between the mean power of the target spectral band and the mean power of all the other three (3) undesired spectral bands was found to be 2.42 (numerical) and 2.21 (experimental) based on the matrices shown in FIGS. 11C and 11D, respectively, providing a decent agreement between the numerical and experimental (3D-fabricated) models of the diffractive multispectral imager.

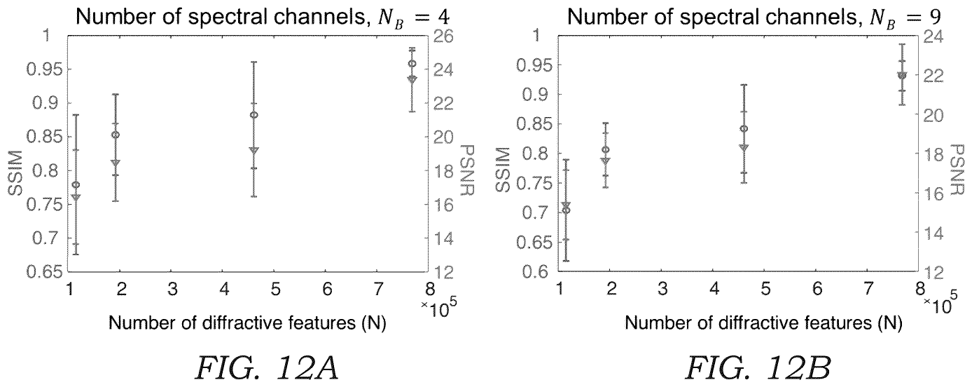

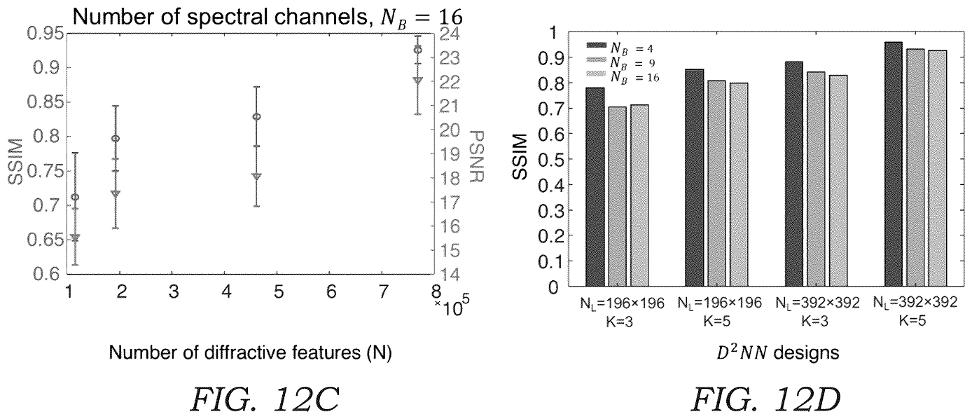

In general, a key design parameter in diffractive optical networks 10 is the number of diffractive features, N, that are engineered using deep learning since it directly determines the number of independent degrees of freedom in the system. FIGS. 12A-12C compare the multispectral imaging quality achieved by four different diffractive network 10 architectures as a function of N for N_{B}=4, 9 and 16, respectively. For example, the diffractive multispectral imager 2 designs for N_{B}=9 and N_{B}=16 shown in FIGS. 6A and 8A, respectively, contain in total N=392×392×5 trainable diffractive features equally distributed over K=5 diffractive layers, i.e., the number of diffractive features per layer is, N_{L}=392×392. While these two diffractive multispectral imagers can achieve average SSIM (PSNR) values of 0.93 (22.06 dB) and 0.92 (22.00 dB) at their output images, respectively, the diffractive multispectral imager architectures with fewer N cannot match their performance. For instance, in the case of a diffractive multispectral imager design based on N_{B}=9, N_{L}=196×196 and K=3 (see FIG. 12B), the average output SSIM and PSNR values drop to 0.7 and 15.38 dB, respectively. FIG. 12D further illustrates the impact of N_{B} on the multispectral imaging performance of diffractive optical networks 10 for four different combinations of N_{L} and K. One can observe in FIG. 12D that for a fixed N_{L} and K combination, the multispectral imaging performance is inversely proportional to N_{B}, which is expected due to the increased level of spectral multiplexing. As a comparison, the average SSIM (PSNR) values attained by the diffractive multispectral imager 2 with the smallest N=196×196×3 increase from 0.7 (15.38 dB) to 0.78 (16.44 dB) when N_{B}=9 is reduced to N_{B}=4 spectral bands; this once again points to the relationship between N and N_{B}, indicating that a larger N_{B} would require additional diffractive degrees of freedom (a larger N) in order to perform the desired multispectral imaging task over a larger set of spectral bands.

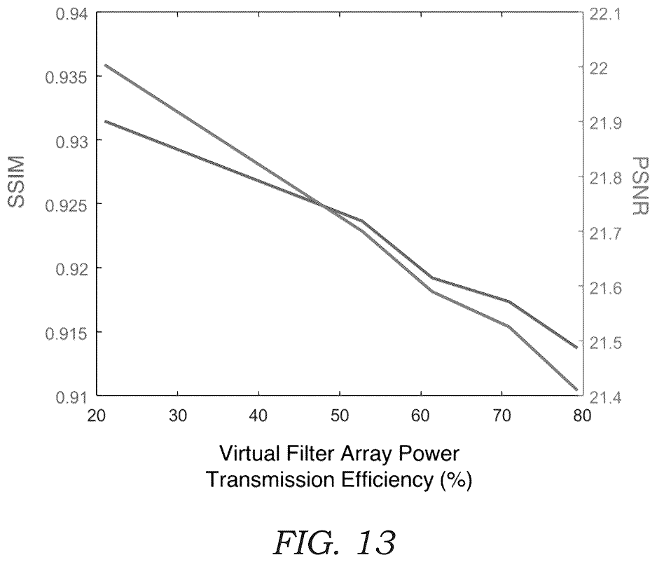

Another critical figure of merit regarding the design of diffractive multispectral imagers is the power transmission efficiency of the optically synthesized virtual spectral filter array 26. FIGS. 7C and 9C illustrate the power transmission efficiencies of the virtual filter arrays generated by the diffractive multispectral imager networks 2 with N_{B}=9 and N_{B}=16 distinct bands within the visible spectrum. For example, based on the data depicted in FIG. 7C, the highest and lowest transmission efficiencies for N_{B}=9, are found as 21.56% and 20.70% at 450 nm and 700 nm, respectively. On average, this diffractive multispectral imager 2 can provide 20.96% virtual filter transmission efficiency for N_{B}=9 spectral bands targeted by the 3×3 repeating cell of the virtual spectral filter array 26. However, the deep learning-based training of this diffractive multispectral imager 2 shown in FIG. 6A focused solely on the quality of the multispectral optical imaging, i.e., the output diffraction efficiency related training loss term ( [symbol] ₑ) was dropped in Eq. 8 (see the Methods section). While this training strategy drives the evolution of the diffractive surfaces to maximize the multispectral imaging performance, the associated virtual filter array transmission efficiency reflects only a lower performance bound that can be achieved by a diffractive multispectral imager 2 with the same optical architecture. To find a better balance between the multispectral imaging quality and the power efficiency of the virtual spectral filter array 26, the loss function that guides the diffractive multispectral imager design during its deep learning-based training can include an additional term, [symbol] ₑ, penalizing poor diffraction efficiencies (see the Methods section). The multiplicative constant, γ, in Eq. 8 determines the weight of the diffraction efficiency penalty, [symbol] ₑ, controlling the trade-off between the multispectral imaging quality and the power efficiency of the associated virtual spectral filter array. To quantify the impact of [symbol] ₑ and γ on the performance of diffractive multispectral imagers, new diffractive models were trained that share an identical optical architecture with the diffractive multispectral imager 2 shown in FIG. 6A (N_{B}=9 within the visible spectrum), where each design used a different value of γ. The results of this analysis are shown in FIG. 13, which indicate that it is possible to create a 5-layer diffractive multispectral imager with N_{B}=9, achieving an average virtual spectral filter transmission efficiency as high as 79.32%. Furthermore, the compromise in multispectral image quality in favor of this significantly increased power transmission efficiency turned out to be only minimal: while the average SSIM (PSNR) values achieved by the lower efficiency diffractive optical networks 10 shown in FIG. 6A were 0.93 (22.06 dB), the more efficient diffractive multispectral imager design with 79.32% average virtual filter array transmission efficiency achieves an SSIM of ~0.91 and a PSNR of 21.42 dB (see FIG. 13).

In addition to diffraction efficiency, other practical concerns that might significantly impact the performance of the diffractive multispectral imagers 2 include optomechanical misalignments and surface back-reflections. The former might be partially mitigated by using high-accuracy 3D fabrication tools such as two-photon polymerization; the latter, on the other hand, could potentially be addressed with anti-reflective coatings frequently used in the fabrication of high-quality lenses. It should also be noted that some of the earlier studies on multi-layer diffractive networks showed that surface reflections, in general, did not lead to a significant discrepancy between the outputs predicted by the numerical forward models/designs and their experimental counterparts. Furthermore, some of these error sources, e.g., layer-to-layer misalignments, can directly be incorporated into the optical training forward model as random variables to drive and shape the deep learning-based evolution of the diffractive layer(s) 12 towards robust solutions that exhibit relatively flat performance curves within the possible error ranges. In fact, this approach was used to ‘vaccinate’ the fabricated diffractive multispectral imager shown in FIG. 10C against (1) lateral misalignments in both x and y directions, (2) axial misalignments along the optical axis and (3) in-plane diffractive layer rotations covering 4 different geometrical degrees of freedom. An important aspect of these vaccinated diffractive optical networks is that they can maintain their performance within the error ranges modeled during their training. For instance, a diffractive optical image classification network can provide a flat blind testing accuracy within the trained range of misalignments; similarly, the fabricated diffractive multispectral imager 2 shown in FIG. 10C achieves relatively flat SSIM and PSNR curves for the output images within the error range that it was trained for. Although, this diffractive network vaccination scheme can, in principle, be extended to cover all 6 degrees of freedom, the inclusion of the two remaining rotational variations (out of the plane of each layer) brings a computational burden on the forward training model of the diffractive networks since they require the light diffraction between successive layers be accurate for tilted planes. Beyond these sources of error discussed above, the experimental results might have also been affected by the optoelectronic detection noise and the deviation of the illumination wavefront with respect to a uniform plane wave assumed during the training.

In the forward optical model of the diffractive multispectral imagers 2 disclosed herein, the wave propagation in between the diffractive layers 12 was modeled using the Rayleigh-Sommerfeld diffraction integral, which takes into account all the propagating modes within the spatial band supported by free space, including the waves at oblique angles with respect to the optical axis; stated differently, the forward model of the presented diffractive multispectral imagers is based on a numerical aperture of 1 in air. This rich design space provided by diffractive network-based imagers optimized using deep learning opens up new avenues, such as the engineering of spatially-varying point-spread functions between an input and an output field-of-view. It should also be emphasized that the diffractive multispectral imager 2 framework using deep learning-based optimization of phase-only diffractive layers can also be extended to spatially incoherent illumination. One way to realize such a design using deep learning is to decompose each spatially incoherent wavefront at a given band into field amplitudes with random 2D input phase patterns, and the output image can be synthesized by averaging the intensities resulting from various independent random phase patterns for the same input field amplitude. The downside of such an incoherent multispectral imager design is that it would take much longer to converge using deep learning since each forward operation during the training phase would need many independent runs with random input phase patterns for each batch of the multispectral training input images. At the cost of a longer one-time training effort, phase-only diffractive layers 12 can also be optimized using deep learning to create a spatially incoherent snapshot multispectral imager 2, following the same design principles outlined herein. Therefore, the extension of the diffractive multispectral imager 2 to process spatially-incoherent light enables the integration of these diffractive optical networks 10 with existing ambient light-based lens-based imaging devices 40 (e.g., camera systems) for multispectral imaging and information processing.

Another interesting aspect of the diffractive multispectral imager 2 designs is that although the desired spatial distribution of different spectral bands over the output image sensor is periodic, this periodicity does not apply to the diffractive surface profiles shown in FIGS. 6A-6D, 8A-8D, 14A-14C. Despite the relatively small layer-to-layer distances used in the designs, the deep learning-based training converges to nonperiodic surface designs, one diffractive layer following another. Due to the data-driven nature of the training, the evolution of the diffractive surfaces is mainly affected by the spatial profiles of the wavelength-dependent transmission of the input objects. Stated differently, the topology of the diffractive layer 12 designs depends on the dataset used for modeling the wavelength-dependent optical transmission of the input objects 21.

Finally, the diffractive designs are based on isotropic materials that do not exhibit any polarization-dependent modulation such as birefringence; therefore, a given modulation unit over a diffractive layer 12 treats all the polarization states carried by a wavelength component equally, imposing the same phase delay regardless of the input polarization state. Hence, the multispectral imaging capability and the virtual spectral filter responses of the diffractive optical networks 10 are independent of the input polarization state of the illumination light, which provides an important advantage.

In summary, snapshot diffractive multispectral imagers 2 can create a virtual spectral filter array 26 over the pixels of a monochrome focal-plane-array or image sensor 22 without the need for a conventional filter array, while simultaneously establishing an imaging condition between the input and output fields-of-view. Owing to their extremely compact form factor, power-efficient optical forward operation (reaching >79% filter transmission efficiency) and high-quality spectral filtering capabilities, the presented diffractive multispectral imagers 2 can be useful for numerous imaging and sensing applications, covering different parts of the spectrum where high-density and wide-area multispectral filter arrays are not readily available.

### Materials and Methods

### Training Forward Model of Diffractive Multispectral Imagers—Optical Forward Model

The D²NN framework for the diffractive multispectral imagers 2 uses deep learning to devise the transmission/reflection coefficients of diffractive features (i.e., physical features 24) located over a series of optical modulation surfaces or layers 12. The modulation coefficient over each diffractive feature/neuron is controlled through one or more physical design variables. The diffractive multispectral imagers 2 were designed to be fabricated based on a single dielectric material and the material thickness, h, was selected as the physical parameter for controlling the complex-valued modulation coefficient associated with each diffractive feature. For a given diffractive layer 12, the transmittance coefficient of a diffractive feature located on the l^{th} layer at a coordinate of (x_{q}, y_{q}, zᵢ) is defined as,

$$t ( {x}_{q} , {y}_{q} , {z}_{l} ) = exp ( \frac{- 2 π κ h ( {x}_{q} , {y}_{q} , {z}_{l} )}{λ} ) exp ( \frac{- j 2 π ( n - {n}_{m} ) h ( {x}_{q} , {y}_{q} , {z}_{l} )}{λ} ) \qquad ( 1 )$$

where n and K denote the real and imaginary parts of the refractive index of the fabrication dielectric material, respectively, and nₙ=1 corresponds to the refractive index of the propagation medium (air) between the layers 12. In the case of the diffractive multispectral imagers 2 designed to operate at the visible wavelengths, the material of the diffractive layers 12 was selected as Schott glass of type ‘BK7’ due to its wide availability and low absorption. Since its absorption coefficient for the visible spectrum is on the order of 10⁻³ cm⁻¹, the imaginary part of the refractive index was ignored, i.e., it was assumed to be absorption-free; considering the fact that the diffractive designs extend <45 μm in the axial direction, this is a valid assumption. For the experimentally tested diffractive multispectral imager 2 shown in FIGS. 10C and 11B, on the other hand, the real and imaginary parts of the diffractive materials were measured experimentally using a THz spectroscopy system, i.e., n=1.6524, 1.6518, 1.6512, 1.6502, and K=0.05, 0.06, 0.06, 0.06, at 0.375, 0.400, 0.425 and 0.450 THz, respectively.

Each diffractive layer 12 was modeled as a multiplicative thin modulation surface in the optical forward model. The light propagation between successive diffractive layers 12 was implemented based on the Rayleigh-Sommerfeld scalar diffraction theory; since the smallest diffractive features considered here have a size of ~λ/2 this is a valid assumption for all-optical processing of diffraction-limited traveling/propagating fields, without any evanescent waves. According to this diffraction formulation, the free-space diffraction is interpreted as a linear, shift-invariant operator with an impulse response of,

$$w ( x , y , z ) = \frac{z}{{r}^{2}} ( \frac{1}{2 π r} + \frac{n}{j λ} ) exp ( \frac{j 2 π nr}{λ} ) \qquad ( 2 )$$

where r=\sqrt{x²+y²+z²}. Based on Eq. 2, q^{th} diffractive feature on the l^{th} layer, at (x_{q}, y_{q}, zₗ), can be described as the source of a secondary wave, generating the field in the form of,

$${w}_{q}^{l} ( x , y , z ) = \frac{z - {z}_{l}}{{( {r}_{q}^{l} )}^{2}} ( \frac{1}{2 π {r}_{q}^{l}} + \frac{n}{j λ} ) exp ( \frac{j 2 π {nr}_{q}^{l}}{λ} ) \qquad ( 3 )$$

$$where {r}_{q}^{l} = \sqrt{{( x - {x}_{q} )}^{2} + {( y - {y}_{q} )}^{2} + {( z - {z}_{l} )}^{2} .}$$

These secondary waves created by the diffractive features on the diffractive layer l propagate to the next layer, i.e., the (l+1)^{th} layer and are spatially superimposed. Accordingly, the light field incident on the p^{th} diffractive feature at (xₚ, yₚ, zₗ₊₁) can be written as

$${\sum }_{q} {A}_{q}^{l} {w}_{q}^{l} ( {x}_{p} , {y}_{p} , {z}_{l + 1} ) , where {A}_{q}^{l}$$

is the complex amplitude of the wave field right after the q^{th} diffractive feature of the l^{th} layer. This field is modulated through the field transmittance of the diffractive unit at (xₚ, yₚ, zₗ₊₁), i.e., t(xₚ, yₚ, zₗ₊₁), where a new secondary wave is generated, described by:

$${u}_{p}^{l + 1} ( x , y , z ) = {w}_{p}^{l + 1} ( x , y , z ) t ( {x}_{p} , {y}_{p} , {z}_{l + 1} ) {\sum }_{q} {A}_{q}^{l} {w}_{q}^{l} ( {x}_{p} , {y}_{p} , {z}_{l + 1} ) . \qquad ( 4 )$$

The outlined successive modulation and the secondary wave generation processes continue until the waves propagating through the diffractive network reach the output image plane. Although the forward optical model described by Eqs. 1-4 is given over a continuous 3D coordinate system, during the deep learning-based training of the presented diffractive optical networks 10, all the wave fields and the modulation surfaces were represented based on their discrete counterparts. For the diffractive multispectral imager designs operating at the visible bands, the spatial sampling rate was set to be 0.5λ_{N}_{_{B}}=225 nm for both N_{B}=4 and 9, which was also equal to the size of a diffractive feature. For the experimentally tested diffractive multispectral imager 2, on the other hand, the sampling rate was selected as 0.375λ_{N}_{_{B}} and the size of each diffractive feature was taken as 0.75λ_{N}_{_{B}} with N_{B}=4.

### Design of Diffractive Multispectral Imagers Operating at Visible Bands

For a given dispersive object defined by the spectral intensity image cube, i.e., the target/ground truth, Iᵢₙ(x, y, λ), located at the input plane, z=zᵢ, the underlying complex-valued field was assumed to be Uᵢₙ(x, y, λ)=\sqrt{Iᵢₙ(x, y, λ)}. In the forward model, it was assumed that the input light is spatially-coherent with a constant phase front across the diffractive network input aperture (spanning a width of ~72 λm) at each wavelength; accordingly, the relative phase delays between different spectral components are not important, i.e., can be arbitrary, without impacting the output multispectral image intensities. Without loss of generality, diffractive multispectral imagers 2, depending on the application of interest, can be trained with any dispersive object model, including different input phase functions.

The size of the input/output FOVs of the diffractive multispectral imagers 2 operating in the visible band was set to be 61.71λ₁×61.71λ₁, defining a unit magnification optical imaging between the object plane 16 and the output plane 18 (i.e., also the sensor plane). The unit magnification is not a necessary assumption for the diffractive multispectral imaging framework, and all the presented designs/methods can be extended to work under a magnification or demagnification factor, for example, by placing the diffractive layers 12 between the image plane of a camera and a monochrome focal plane array or image sensor. The size of each pixel at the monochrome image sensor-array 22 was assumed to be ~1.28λ₁×1.28λ₁, corresponding to N_{S}=48 pixels in each direction (x and y). These 48×48 pixels were grouped into 2×2, 3×3 and 4×4 blocks during the training of the diffractive multispectral imagers targeting N_{B}=4, N_{B}=9 and N_{B}=16 spectral bands, respectively. Based on these pixel grouping schemes, the EMNIST images representing the intensity patterns of the input objects were interpolated to a size 24×24, 16×16 and 12×12 pixels for the diffractive designs with N_{B}=4, N_{B}=9 and N_{B}=16 spectral bands, respectively. Note that the original size of the images in the EMNIST dataset is 28×28; hence, the ground truth images as well as the output spectral channels shown in FIGS. 6B and 8B have a slightly lower resolution than the original EMNIST data.

Each of the diffractive layers 12 shown in FIGS. 6A and 8A contains N_{L}=392×392 diffractive features, where the physical size of each diffractive layer 12 was set as 126λ₁×126λ₁. Since the diffractive feature size was kept identical in all the models reported in FIGS. 12A-12D, the modulation surfaces constituting the diffractive multispectral imagers designed based on N_{L}=196×196 features per layer, occupy a smaller area of 63λ₁×63λ₁. The layer-to-layer (axial) distances in all these diffractive multispectral imagers were taken as 15.43λ₁.

The input intensity patterns (ground truth) describing the wavelength-dependent modulation function of the input objects, sampled at a rate 0.5λ_{N}_{_{B}}=0.32λ₁, were represented as 3D discrete vectors of size 192×192×N_{B} denoted by Iᵢₙ[m, n, w] with m=1, 2, 3, . . . , 192, n=1, 2, 3, . . . , 192 and w=1, 2, 3, . . . , N_{B}. The resolution of an image representing the intensity pattern of a given input object in a spectral band depends on the number of spectral bands in the system. A two-step interpolation was used to match the feature size of the input images to the size of a virtual spectral filter array. Assuming that there are N_{B} many images from the training dataset to represent an input object at different spectral bands, i.e., I[x, y, w], each image of a given spectral band was first interpolated to a size of N_{S}/\sqrt{N_{B}}×N_{S}/\sqrt{N_{B}}. These N_{B} low-resolution images, I_{GT,LR}[k, r, w], represents the spectral channels of the ground truth multispectral image cube extracted through the demosaicing step at the output image plane. To generate input fields matching the spatial sampling of the forward optical model, i.e., Iᵢₙ[m, n, w], in the second step, each low-resolution image was upsampled to a size of 192×192 with each pixel corresponding to an amplitude transmittance coefficient over a physical area of 0.32λ₁×0.32λ₁=225×225 nm².

Based on these definitions, a spatial structural loss function was used defined as:

$$\text{?} = \frac{1}{{N}_{S}} \frac{1}{{N}_{S}} \frac{1}{{N}_{B}} {\sum }_{q = 1}^{{N}_{S}} {\sum }_{p = 1}^{{N}_{S}} {\sum }_{w = 1}^{{N}_{B}} {\vert {I}_{GT} [ q , p , w ] - σ {I}_{S} [ q , p , w ] \vert}^{2} , \qquad ( 5 )$$

where, I_{GT} refers to the 3D ground-truth image cube with a size of N_{S}×N_{S}×N_{B}, where for each spectral channel w, there are zeros introduced into proper locations representing the virtual pixels assigned to N_{B}−1 other spectral channels for each virtual filter array period. The variable I_{S} in Eq. 5 denotes the optically synthesized 3D image cube at the output plane of a diffractive network that is being trained. To compute I_{S} based on the output optical intensity created by a diffractive optical network, Iₒᵤₜ[m, n, w], a pixel binning was applied based on the average pooling operator with strides on both dimensions equal to 4 (900 nm/225 nm=4, which refers to the ratio of the image detector pixel size to the simulation pixel size of the forward model). The multiplicative parameter, σ, in Eq. 5 is a normalization constant that accounts for the variations in the output optical power and it is updated for every batch of the training image samples based on,

$$σ = \frac{{\sum }_{q = 1}^{{N}_{S}} {\sum }_{p = 1}^{{N}_{S}} {\sum }_{w = 1}^{{N}_{B}} {I}_{GT} [ q , p , w ] {I}_{S} [ q , p , w ]}{{\sum }_{q = 1}^{{N}_{S}} {\sum }_{p = 1}^{{N}_{S}} {\sum }_{w = 1}^{{N}_{B}} {{I}_{S} [ q , p , w ]}^{2}} . \qquad ( 6 )$$

To increase the output power efficiency, an additional loss term, [symbol] , was utilized to balance the structural loss term defined in Eq. (5). For the power-efficient designs depicted in FIG. 13, [symbol] ₑ was defined as [symbol] ₑ=e^{-η}, with

$$η = \frac{{\sum }_{m} {\sum }_{n} {\sum }_{w} {I}_{out} [ m , n , w ]}{{\sum }_{m} {\sum }_{n} {\sum }_{w} {I}_{in} [ m , n , w ]} \times 100. \qquad ( 7 )$$

Therefore, the overall training loss function, [symbol] ′, was defined as a linear combination of [symbol] ₑ and [symbol] , i.e.,

$${\text{?}}^{′} = \text{?} + γ {\text{?}}_{e} \qquad ( 8 )$$

with the multiplicative constant γ controlling the balance between the multispectral imaging performance and the output power efficiency of the associated diffractive network model.

For a given spectral channel, w′, the virtual filter array transmission efficiency, T_{w′}, presented in FIGS. 7C, 9C and 13 was calculated based on,

$${T}_{{w}^{′} =} \frac{{\sum }_{k} {\sum }_{r} {I}_{S , LR} [ k , r , {w}^{′} ]}{{\sum }_{k} {\sum }_{r} {I}_{GT , LR} [ k , r , {w}^{′} ]} \times 100 , \qquad ( 9 )$$

where I_{S,LR}[k, r, w′] refers to an image of size N_{S}/\sqrt{N_{B}}×N_{S}/\sqrt{N_{B}} created by the demosaicing of I_{S}[m, n, w′]. The image, I_{GT,LR}[k, r, w′], on the other hand, represents the N_{S}/\sqrt{N_{B}}×N_{S}/\sqrt{N_{B}} optical intensity at the spectral channel w′, based on the demosaiced version of the ground truth image, I_{GT}[m, n, w′].

During the training of a diffractive multispectral imager 2, the evolution of the phase profiles of the diffractive layers 12 is guided through the gradients of the loss function with respect to the learnable physical parameters of the system, i.e., the material thickness values of each diffractive layer 12. To limit the range of the material thickness values provided by the stochastic gradient descent-based iterative updates, the thickness over each diffractive feature of a given diffractive layer was defined as a function of an associated auxiliary variable hₐ,

$$h ( {h}_{a} ) = \frac{sin ( {h}_{a} ) + 1}{2} ( {h}_{m} - {h}_{b} ) + {h}_{b} \qquad ( 10 )$$

where hₘ and h_{b} denote the maximum modulation thickness and the base material thickness, respectively. For the presented diffractive multispectral imagers 2 operating at the visible part of the electromagnetic spectrum, hₘ was set to be 1.4 μm, while h_{b} was taken as 0.7 μm.

### Design of the Experimentally Tested Diffractive Multispectral Imager Operating at Terahertz Bands

As shown in FIGS. 10A-10C, the size of the input and output FOVs of the experimentally tested diffractive multispectral imager 2 with N_{B}=4 were set to be 37.5λ₁×37.5λ₁, where λ₁~0.8 mm is the wavelength at 0.375 THz. It was assumed that the THz output image plane 18 has 100 (10×10) pixels of size 3.75λ₁×3.75λ₁. Since N_{B}=4, these 10×10 pixels were divided into groups of 2×2 virtual spectral filters 26 repeating in space. The fabricated diffractive multispectral imager 2 was trained using randomly generated intensity patterns, representing the amplitude transmission of the input objects. The 3D-printed blind test object is the letter ‘U’ designed based on a 5×5 binary image with each pixel corresponding to an area of 7.5λ₁×7.5λ₁.

The size of each diffractive feature (e.g., physical features 24) on the 3D-printed diffractive layers 12 shown in FIGS. 10B-10C equals ~0.5 mm×0.5 mm. Each of the three (3) fabricated diffractive layers 12 processes the incoming waves based on 100×100 optimized diffractive features, extending over 62.5λ₁×62.5λ₁. In the optical forward model of this diffractive network, all the axial distances between (1) the input FOV and the first diffractive surface, (2) two successive diffractive surfaces and (3) the last diffractive layer and the output FOV were set to be 40 mm, i.e., ~50λ₁. The variables hₘ and h_{b} in Eq. 10 were taken to be 1.56λ₁ and 0.625λ₁, respectively.

The fabricated diffractive multispectral imager 2 shown in FIGS. 10A-10C was trained based on [symbol] ′ depicted in Eq. 8 with γ=0.15. Based on this γ value, the K=3 layer diffractive optical network 10 shown in FIGS. 10A-10C provides 5.68%, 5.32%, 5.2% and 5.01% virtual filter array transmission efficiency (T) for the spectral components at 0.375 THz, 0.4 THz, 0.425 THz and 0.45 THz, respectively.

The forward model of a 3D-printed diffractive optical network 10 is prone to physical errors, e.g., layer-to-layer misalignments. To mitigate the impact of these experimental error sources, such misalignments were modeled as random variables and incorporated into the forward training model so that the deep learning-based evolution of the diffractive surfaces is enforced to converge to solutions that show resilience against implementation errors. Accordingly, the diffractive optical network 10 design shown in FIGS. 10A-10C was vaccinated against random 3D layer-to-layer misalignments in the form of lateral and axial translations as well as in-plane rotations. For this, four uniformly distributed random variables, Dₓ^{l}, D_{y}^{l}, D_{z}^{l} and D_{θ}^{l}, were introduced representing the random errors in the 3D location and orientation of a diffractive layer, l, i.e.,

$${D}_{x}^{l} ∼ U ( - {Δ}_{x} , {Δ}_{x} ) \qquad ( 11 )$$

$${D}_{y}^{l} ∼ U ( - {Δ}_{y} , {Δ}_{y} )$$

$${D}_{z}^{l} ∼ U ( - {Δ}_{z} , {Δ}_{z} )$$

$${D}_{θ}^{l} ∼ U ( - {Δ}_{θ} , {Δ}_{θ} )$$

where Δₓ, Δ_{y}, Δ_{z}, and Δ_{θ} denote the error range anticipated based on the fabrication margins of the experimental system. For the 3D-printed diffractive optical network 10 shown in FIGS. 10A-10C, the range of the random errors for the lateral misplacement of the diffractive layers 12 was taken as Δₓ=Δ_{y}=0.625λ₁. The variable, Δ_{z}, which controls the maximum axial displacement of each layer 12, was set to be 2.5λ₁. The range of errors in the orientation of each layer 12 around the optical axis was assumed to be within (−2°, 2°), i.e., λ_{θ}=2°. During the training stage, Dₓ^{l}, D_{y}^{l}, D_{z}^{l} and D_{θ}^{l} were updated for each layer, l, independently for every batch of input objects, introducing a new set of random misalignment errors into the forward optical model at each error backpropagation step.

The numerically computed and experimentally measured power cross-talk matrices shown in FIGS. 11C, 11D, were computed based on the images of the letter ‘U’ at 4 different illumination wavelengths: ~0.8 mm, ~0.75 mm, ~0.7 mm and ~0.66 mm.

### Details of the Experimental Setup

The schematic diagram of the experimental setup is given in FIG. 10A. In this system, the THz wave incident on the object was generated through a horn antenna 58 compatible with the source WR2.2 modular amplifier/multiplier chain (AMC) 50 from Virginia Diode Inc (VDI) which functioned as the illumination light source 32. Electrically modulated with a 1 kHz square wave via signal generator 56 to resolve low-noise output data through lock-in detection at the lock-in amplifier 54, the AMC 50 received an RF input signal via RF synthesizer 52 that is a 16 dBm sinusoidal waveform at 11.111 GHz (f_{RF1}). This RF signal is multiplied 34, 36, 38 and 40 times to generate a continuous-wave (CW) radiation at ~0.375 THz, ~0.4 THz, ~0.425 THz and ~0.45 THz, corresponding to ~0.8 mm, ~0.75 mm, ~0.7 mm and ~0.66 mm in wavelength, respectively. The exit aperture of the horn antenna 58 was placed ~60 cm away from the object plane of the 3D-printed diffractive optical network 10 so that the beam profile of the THz illumination closely approximates a uniform plane wave. The diffracted THz light at the output plane 18 was collected using a single-pixel Mixer/AMC from Virginia Diode Inc. (VDI) 60. A 10 dBm sinusoidal signal at 11.083 GHz (f_{RF2}) was sent to the detector as a local oscillator for mixing so that the down-converted signal is at 1 GHz. The 37.5λ₁×37.5λ₁ output FOV was scanned by placing the single-pixel detector on an XY stage that was built by combining two linear motorized stages (Thorlabs NRT100). The scanning step size was set to be 1 mm~1.25λ₁. The XY scanning of the single-pixel detector allows the detector to capture images in the XY plane like an image sensor 22. The down-converted signal of a single-pixel detector at each scan location was sent to low-noise amplifiers 64 (Mini-Circuits ZRL-1150-LN+) to amplify the signal by 80 dBm and a 1 GHz (+/−10 MHz) bandpass filter 66 (KL Electronics 3C40-1000/T10-O/O) to clean the noise coming from unwanted frequency bands. Following the amplification, the signal was passed through a tunable attenuator 68 (HP 8495B) and a low-noise power detector 70 (Mini-Circuits ZX47-60), and then the output voltage was read by a lock-in amplifier 54 (Stanford Research SR830). The modulation signal using signal generator 56 was used as the reference signal for the lock-in amplifier 54 and accordingly, a calibration was conducted by tuning the attenuation and recording the lock-in amplifier readings. The lock-in amplifier readings at each scan location were converted to a linear scale according to the calibration.

The diffractive multispectral imager 2 was fabricated using a 3D printer (Objet30 Pro, Stratasys Ltd.). The optical architecture of the 3D-printed diffractive optical network 10 consisted of an input object and three (3) diffractive layers 12 (see FIGS. 10A-10C). While the active modulation area of the 3D-printed diffractive layers 12 was 5 cm×5 cm (62.5λ₁×62.5λ₁), they were printed as light-modulating insets surrounded by a uniform slab of the printing material with a thickness of 2.5 mm.

### Training Details and Image Quality Metrics

The image quality metrics SSIM and PSNR were computed based on the comparison between the low-resolution ground-truth image cube, I_{GT,LR}[k, r, w], and the output image cube formed through the demosaicing of the optical intensity patterns collected by the image sensor, I_{S,LR}[k, r, w]. Both PSNR and SSIM metrics were computed separately for each spectral channel. The PSNR achieved by a diffractive multispectral imager for the spatial information in a spectral band, w′, was computed based on,

$${PSNR}_{{w}^{′}} = 20 {log}_{10} ( \frac{1}{\sqrt{{\sum }_{k} {\sum }_{r} {\vert {I}_{GT , LR} [ k , r , {w}^{′} ] - {I}_{S , LR} [ k , r , {w}^{′} ] \vert}^{2}}} ) , \qquad ( 12 )$$

To compute the SSIM metric, the built-in tf.image.ssim( ) function in TensorFlow was used based on its default parameters. Each data point in SSIM and PSNR values shown in FIGS. 6D and 8D represents the average value calculated using 2080 blind test objects created in a way that the amplitude channel of the spatial transmission function at each spectral band was modeled based on an image randomly selected from the 18.8K test images of the EMNIST dataset.

The deep learning-based training of the diffractive networks was implemented using Python (v3.6.5) and TensorFlow (v1.15.0, Google Inc.) software 104. The backpropagation updates were calculated using the Adam optimizer, and its parameters were taken as the default values in TensorFlow and kept identical in each model. The learning rates of the digital diffractive optical networks 10 were set to be 0.001. The training batch size was taken as 8 during the deep learning-based training of all the presented diffractive multispectral imagers 2. The training of a 5-layer diffractive optical network 10 with 392×392 diffractive features per layer (for 100 epochs) takes approximately 2 weeks using a computer with a GeForce GTX 1080 Ti Graphical Processing Unit (GPU, Nvidia Inc.) and Intel® Core™ i7-8700 Central Processing Unit (CPU, Intel Inc.) with 64 GB of RAM, running Windows 10 operating system (Microsoft). Although the training time for the deep learning-based design of a diffractive multispectral imager 2 is relatively long, it should be noted that this is a one-time effort. Once the diffractive multispectral imager 2 is manufactured or fabricated following the training stage, its physical forward optical operation consumes no power except, in certain embodiments, the power needed for the illumination light source 32.

While embodiments of the present invention have been shown and described, various modifications may be made without departing from the scope of the present invention. For example, while the diffractive optical network 10 has been largely described in the context of transmissive layers 12 it should be appreciated that the diffractive optical network 10 may also include reflective layers 12 (or combinations of transmissive and reflective layers 12). The invention, therefore, should not be limited, except to the following claims, and their equivalents.

1. A diffractive optical network for performing multispectral imaging of one or more objects comprising:
one or more optically transmissive and/or reflective layers arranged in one or more optical paths, each of the one or more optically transmissive and/or reflective layers comprising a plurality of physical features located in different locations in each of the layers and having different valued transmission and/or reflection parameters as a function of lateral coordinates across each layer, wherein the one or more optically transmissive and/or reflective layers and the plurality of physical features collectively receive illumination light from the one or more objects and generate a filtered image of the one or more objects at an output plane with a virtual spectral filter array comprising periodically repeating cells located at the output plane, wherein each periodically repeating cell has one or more members capturing at least one wavelength or at least one wavelength range or band; and
a monochrome image sensor or an opto-electronic detector located at the output plane and positioned to capture a spectrally filtered image of the one or more objects by the virtual spectral filter array.

2. The diffractive optical network of claim 1, further comprising a natural or external illumination light source that illuminates one or more objects at a plurality of wavelengths, wavelength ranges, or bands.

3. The diffractive optical network of claim 1, wherein each member of the periodically repeating cells of the virtual spectral filter array has a distinct filter function that passes one or more wavelengths, wavelength ranges, or bands.

4. The diffractive optical network of claim 1, further comprising demosaicing circuitry or software configured to generate a demosaiced image cube from the spectrally filtered image.

5. The diffractive optical network of claim 1, wherein the virtual spectral filter array is spatially ordered or spatially disordered.

6. The diffractive optical network of claim 2, wherein the external illumination light source illuminates one or more objects at a plurality of wavelengths, wavelength ranges, or bands either sequentially or simultaneously.

7. The diffractive optical network of claim 2, wherein the illumination light comprises spatially-coherent light or spatially-incoherent light.

8. A diffractive optical network for performing multispectral imaging on an input image comprising:
one or more optically transmissive and/or reflective layers arranged in one or more optical paths, each of the one or more optically transmissive and/or reflective layers comprising a plurality of physical features located in different locations in each of the one or more layers of the network and having different valued transmission and/or reflection parameters as a function of lateral coordinates across each layer, wherein the one or more optically transmissive and/or reflective layers and the plurality of physical features collectively receive the input image and generate a spectrally filtered image of the input image at an output plane with a virtual spectral filter array comprising periodically repeating cells located at the output plane, wherein each periodically repeating cell has one or more members capturing at least one wavelength or at least one wavelength range or band; and
a monochrome image sensor or an opto-electronic detector located at the output plane and positioned to capture the spectrally filtered image of the input image by the virtual spectral filter array.

9. The diffractive optical network of claim 8, wherein each member of the periodically repeating cells of the virtual spectral filter array has a distinct spectral filter function that passes one or more wavelengths, wavelength ranges, or bands.

10. The diffractive optical network of claim 8, further comprising demosaicing circuitry or software configured to generate a demosaiced image cube from the spectrally filtered image.

11. The diffractive optical network of claim 8, wherein the virtual spectral filter array is spatially ordered or spatially disordered.

12. A method of performing multispectral imaging of one or more objects or an input image comprising:
providing a diffractive optical network comprising:
one or more optically transmissive and/or reflective layers arranged in one or more optical paths, each of the one or more optically transmissive and/or reflective layers comprising a plurality of physical features located in different locations in each of the one or more layers of the network and having different valued transmission and/or reflection parameters as a function of lateral coordinates across each layer, wherein the one or more optically transmissive and/or reflective layers and the plurality of physical features collectively receive multispectral light from the one or more objects or the input image and generate a spectrally filtered image of the one or more objects or the input image at an output plane with a virtual spectral filter array comprising periodically repeating cells located at the output plane wherein each periodically repeating cell has one or more members capturing at least one wavelength or at least one wavelength range or band; and
a monochrome image sensor or an opto-electronic detector located at the output plane and positioned to capture the spectrally filtered image of the one or more objects or the input image; and
inputting the multispectral light from the one or more objects or the input image to the diffractive optical network;
capturing the spectrally filtered image of the one or more objects or the input image with the monochrome image sensor or the opto-electronic detector; and
generating a demosaiced image cube of the spectrally filtered image of the one or more objects or the input image.

13. The method of claim 12, wherein each member of the repeating cells of the virtual spectral filter array has a distinct spectral filter function that passes one or more wavelengths, wavelength ranges, or bands.

14. The method of claim 12, wherein the virtual spectral filter array is spatially ordered or spatially disordered.

15. The method of claim 12, wherein the multispectral light illuminates one or more objects at a plurality of wavelengths, wavelength ranges, or bands either sequentially or simultaneously.

16. The method of claim 12, wherein the multispectral light comprises spatially-coherent or spatially-incoherent light.

17. The method of claim 12, wherein the multispectral light from the one or more objects or the input image is generated by a lens-based imaging device.

18. The method of claim 12, further comprising displaying one or more spectral images or slices of the demosaiced image cube of the spectrally filtered image of the one or more objects or the input image.
